(19) United States
(12) Patent Application Publication
(10) Pub. No.: US 2018/0322585 A1
(43) Pub. Date: Nov. 8, 2018

(54) MANAGEMENT SUPPORT DEVICE AND MANAGEMENT SUPPORT METHOD

(71) Applicant: TOKYO INSTITUTE OF TECHNOLOGY, Meguro-ku Tokyo (JP)

(72) Inventor: Hiroshi DEGUCHI, Meguro-ku Tokyo (JP)

(21) Appl. No.: 15/773,780

(22) PCT Filed: Oct. 26, 2016
(86) PCT No.: PCT/JP2016/081753

§ 371 Date: May 4, 2018

(30) Foreign Application Priority Data
Nov. 5, 2015 (JP) 2015-217891

(51) Int. Cl. G06Q 40/00

(52) U.S. Cl. CPC G06Q 40/12

(57) ABSTRACT

An event acknowledgment unit acknowledges event information including a numerical quantity of an input element constituting an event generated in a predetermined organization and a numerical quantity of an output element constituting the event. A transaction recording unit records transaction information described in a double-entry bookkeeping style, the transaction information being an exchange algebraic representation of the event information, the transaction information indicating the input element as a credit side item and quantifying the input element in units of quantity for the input element, and the transaction information indicating the output element as a debit side item and quantifying the output element in units of quantity for the output element. A support information generation unit generates a plurality of types of support information for supporting management of the organization according to a plurality of schemes, in accordance with the transaction information recorded by the transaction recording unit.

### TECHNICAL FIELD

The present invention relates to a data processing technology and, more particularly, to a management support device and a management support method.

### BACKGROUND ART

The inventor of this disclosure proposes a method of recording transactions of real objects by applying exchange algebra (see, for example, non-patent document 1).

### RELATED ART DOCUMENTS

### Non-Patent Documents

[Non-patent document 1] Hiroshi Deguchi, “Study on economic systems on transaction basis—research program and methodology”, [online], Feb. 21, 2013, Japan Association for Evolutionary Economics, [retrieved on Oct. 10, 2019], Internet <URL:http://c-faculty.chuo-u.ac.jp/˜jafee/papers/Deguchi_Hiroshi2.pdf>

### DISCLOSURE OF INVENTION

### Problems to be Solved by the Invention

In the related-art system for managing manufacturing and service production in an organization, information has been independently managed for respective processes like financial accounting, environment accounting, material flow cost accounting, production planning, etc. Therefore, the related-art management system has grown in scale and the maintenance thereof has required numerous time and cost. Further, revisions and improvements to the system have not been easy.

The inventor of this disclosure has arrived at an idea of building a system for integrated information management related to various events by recording events of manufacturing, service production, etc. as transaction information described in the double-entry bookkeeping format using exchange algebra.

The present invention has been made in view of the foregoing circumstances, and a main purpose thereof is to provide a technology for supporting integrated information management related to various events of manufacturing, service production, etc.

### Means for Solving the Problem

In order to resolve the foregoing problems, a management support device according to one embodiment of the present invention includes: an event acknowledgment unit that acknowledges event information including a numerical quantity of an input element constituting an event generated in a predetermined organization and a numerical quantity of an output element constituting the event; a transaction recording unit that records transaction information described in a double-entry bookkeeping style, the transaction information being an exchange algebraic representation of the event information acknowledged by the event acknowledgment unit, the transaction information indicating the input element as a credit side item and quantifying the input element in units of quantity for the input element, and the transaction information indicating the output element as a debit side item and quantifying the output element in units of quantity for the output element; and an information generation unit that generates a plurality of types of support information for supporting management of the organization according to a plurality of schemes, in accordance with the transaction information recorded by the transaction recording unit.

Another embodiment of the present invention relates to a management support method. The method includes: acknowledging, using a computer, event information including a numerical quantity of an input element constituting an event generated in a predetermined organization and a numerical quantity of an output element constituting the event; recording, using a computer, transaction information described in a double-entry bookkeeping style, the transaction information being an exchange algebraic representation of the event information acknowledged, the transaction information indicating the input element as a credit side item and quantifying the input element in units of quantity for the input element, and the transaction information indicating the output element as a debit side item and quantifying the output element in units of quantity for the output element; and generating, using a computer, a plurality of types of support information for supporting management of the organization according to a plurality of schemes, in accordance with the transaction information recorded.

Still another embodiment of the present invention also relates to a management support method. The method postulates a plurality of scenarios of price, technology (investment in facilities, etc.), environment constraint, etc. based on event information indicating (1) an amount of input of source material, labor, energy, device, (2) an amount of main product, byproduct, and service produced, and evaluates a technology (investment in facilities, etc.) and a plan for production from various perspectives defined by price unit, material unit, evaluation of waste, etc.

Optional combinations of the aforementioned constituting elements, and implementations of the invention in the form of methods, apparatuses, systems, computer programs, data structures, and recording mediums may also be practiced as additional modes of the present invention.

### Advantageous Effects

According to the present invention, it is possible to support integrated information management related to various events of manufacturing, service production, etc.

### BRIEF DESCRIPTION OF DRAWINGS

FIG. 1A and FIG. 1B are diagrams each illustrating an example of a sales slip;

FIG. 2 is a block diagram illustrating a functional configuration of a data editing apparatus according to base technology 2;

FIG. 3 is a diagram illustrating an exemplary user code for operating accounting-type data;

FIG. 4A is a diagram illustrating an execution code that corresponds to the user code shown in FIG. 3;

FIG. 4B is a diagram illustrating an execution code that corresponds to the user code shown in FIG. 3;

FIG. 5 is a diagram illustrating an exemplary user code for operating record-type data;

FIG. 6A is a diagram illustrating an execution code that corresponds to the user code shown in FIG. 5;

FIG. 6B is a diagram illustrating an execution code that corresponds to the user code shown in FIG. 5;

FIG. 7 is a flowchart illustrating an operation of a data editing apparatus;

FIG. 8 schematically shows a relationship between the transaction information and the organization management process;

FIG. 9 shows a configuration of a corporate system according to the embodiment;

FIG. 10 is a block diagram showing a functional configuration of the management support device of FIG. 9;

FIG. 11 schematically shows a process of manufacturing a painted product;

FIG. 12 shows an example of table representation in double-entry bookkeeping;

FIG. 13 shows an example of table representation in double-entry bookkeeping;

FIG. 14 shows an example of BOM; and

FIG. 15 shows an example of service flow information.

### MODE FOR CARRYING OUT THE INVENTION

(Base Technology 1)

An explanation is given of exchange algebra, on which a data editing technology shown in the present embodiment is based, before explaining the configuration of the embodiment of the present invention.

The inventor of the present invention considers that 80 to 90 percent of data in an organization such as a company can be expressed by two data structures shown in the following.

1. Multi-classification numerical value type (hereinafter, also referred to as “accounting type data”)

This is a combination of a data value and a data attribute (hereinafter, also referred to as “basis”) where a numerical value is used as the data value and where a name, a unit, a time, and a subject (entity) are used as the data attribute. For example, data is expressed as: 40<cash, yen>+30<tangerine, piece> . . . .

2. Multi-classification mixed type (hereinafter, also referred to as “record type data”)

This is a combination of a data value and a basis where numerical values or various literals other than a numerical value are used as the data value and the base. For example, data is expressed as: 55<age>+Taro Yamada <name>+Tsugaru <favorite fruit> . . . .

A detailed explanation is given mainly regarding accounting type data in the following.

Accounting type data belongs to an algebraic system (hereinafter, also referred to as “exchange algebra”) for collectively expressing numerical value data provided for each classified item of some sort and then performing calculation and can be also considered as exchange algebra data. A basis (i.e., classification item) in the accounting type data is composed of four items: <name, unit, time, subject>. The data is expressed by a combination of respective values for one or more bases, in other words, the data is expressed by the sum of the values for one or more bases.

x=200<apple,yen,#,#>+400<saury,yen,#,#> Example 1:

y=200<apple,yen,first quarter of 2006,#>+400<apple,yen,second quarter of 2006,#>+720<apple,yen,third quarter of 2006,#> Example 2:

In the above Example 1, both times and entities are omitted. In the above Example 2, the entities are omitted. Example 2 can be also considered as an expression of time-series data. For entities for the bases, identification information of organizations such as a name of a company and the like may be set.

Advantages of expression by exchange algebra include being able to express data using various bases (classifications) and being able to express bases in characters, not in program codes, that are easily understandable to humans. Further, expression by exchange algebra also allows for unified data editing by calculation called transfer as described later.

In exchange algebra according to the embodiment, a symbol, ̂(hat), is used instead of a negative numerical value. For example, an equation, x=20̂<apple, #, #, #>, shows that apples are reduced by 20. In other words, “̂” represents a basis that means an opposite item for offsetting a given item. Also, as an operator showing an offsetting operation, “˜(bar)” is introduced. Examples thereof are shown in the following.

x1=30<cash>+20<apple>+50<debt>

y1=̂x1=30̂<cash>+20̂<apple>+50̂<debt>

˜(y1+x1)=(30̂<cash>+20̂<apple>+50̂<debt>)+(30<cash>+20<apple>+50<debt>)=0

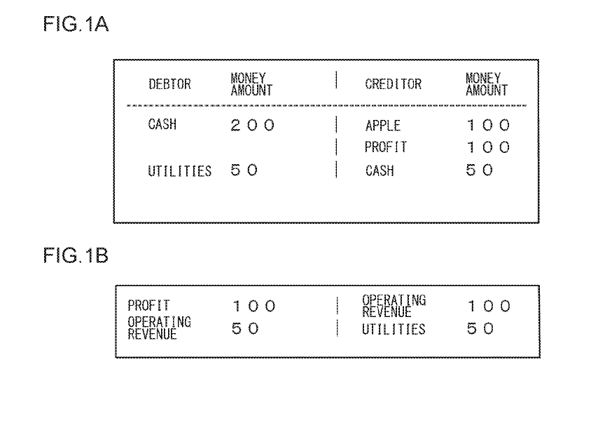

An explanation is now given regarding a transfer operation by exchange algebra. There is an operation called transfer in bookkeeping. This is considered as a type of a recategorization (basis conversion) operation. An example is now shown where a sales slip of a vegetable shop shown in FIG. 1A is transferred to a sales slip shown in FIG. 1B.

Transactions in FIG. 1A and FIG. 1B can be expressed in yen terms as shown in the following.

x1=200<cash,yen>+100̂<apple,yen>+100<profit,yen>

x2=50<utilities,yen>+50̂<cash,yen>

x3=100̂<profit,yen>+100<operating revenue,yen>

x4=50̂<operating revenue,yen>+50̂<utilities,yen>

y=x1+x2+x3+x4=(200<cash,yen>+100̂<apple,yen>+100<profit,yen>)+(50<utilities,yen>+50̂<cash,yen>)+(100̂<profit,yen>+100<operating revenue,yen>)+(50̂<operating revenue,yen>+50̂<utilities,yen>)

˜y=150<cash,yen>+100̂<apple,yen>+50<operating revenue,yen>

An explanation is now given of aggregation and proportional division, which are considered to be transfer operations.

1. Aggregation

It is assumed that there are 300 yen Tsugaru, 200 yen Fuji, and 100 yen Kougyoku (Tsugaru, Fuji, and Kougyoku each are a single breed of apples). This is expressed as: x=300<Tsugaru, yen>+200<Fuji, yen>+100<Kougyoku, yen>. This operation of collectively classifying Tsugaru, Fuji, and Kougyoku as “apple” is a type of a transfer and referred to as aggregation. A map showing a correspondence relationship, {Tsugaru, Fuji, Kougyoku}→{apple}, needs to be provided as a precondition.

In this example, an element, F(x)=300̂<Tsugaru, yen>+200̂<Fuji, yen>+100̂<Kougyoku, yen>+300<apple, yen>+200<apple, yen>+100<apple, yen>, is created in accordance with the above map showing the correspondence relationship. The value of the basis <apple> represents respective values of the bases <Tsugaru>, <Fuji>, and <Kougyoku> to be aggregated. In other words, a totalization value of the respective values of the bases <Tsugaru>, <Fuji>, and <Kougyoku> to be aggregated is calculated as the value of the basis <apple>.

A transfer G(x) that shows aggregation is provided using F(x) as follows: ˜{x+F(x)}. In other words, G(x)=˜{x+F(x)}=(300<Tsugaru, yen>+200<Fuji, yen>+100<Kougyoku, yen>)+(300̂<Tsugaru, yen>+200̂<Fuji, yen>+100̂<Kougyoku, yen>+300<apple, yen>+200<apple, yen>+100<apple, yen>)=600<apple, yen>.

2. Proportional Division

Proportional division is further division of a single classification item into a plurality of classification items. For example, in the example shown in the aggregation, proportional division means division of the value corresponding to the basis <apple> into respective values of Tsugaru, Fuji, and Kougyoku. A proportional division ratio for{apple}→{Tsugaru, Fuji, Kougyoku} needs to be provided as a prerequisite and is 1:1:1 in this case.

In this example, an element, F(x)=600̂<apple, yen>+200<Tsugaru, yen>+200<Fuji, yen>+200<Kougyoku, yen>, is created for x=600<apple, yen> in accordance with the above proportional division ratio.

A transfer G(x) that shows proportional division is provided using F(x) as follows: ˜{x+F(x)}. In other words, G(x)=˜{x+F(x)}=600<apple, yen>+(600̂<apple, yen>+200<Tsugaru, yen>+200<Fuji, yen>+200<Kougyoku, yen>)=200<Tsugaru, yen>+200<Fuji, yen>+200<Kougyoku, yen>.

(Base Technology 2)

An explanation is given in the following regarding an information processing apparatus (hereinafter, referred to as “data editing apparatus”) that performs a data editing process using the idea of the above exchange algebra. In the present embodiment, a user describes data editing details using intensive notation, which is a method of describing a set by providing conditions necessary and sufficient for an object to belong to the set. Based on the editing details described by the intensive notation, the data editing apparatus according to the embodiment outputs a program code described in extensive notation, which is a method of describing a set by listing all the elements of the set. The data editing apparatus then reads data to be edited into memory as a data object in a format that corresponds to exchange algebra and performs an editing process on the data by executing the above program code.

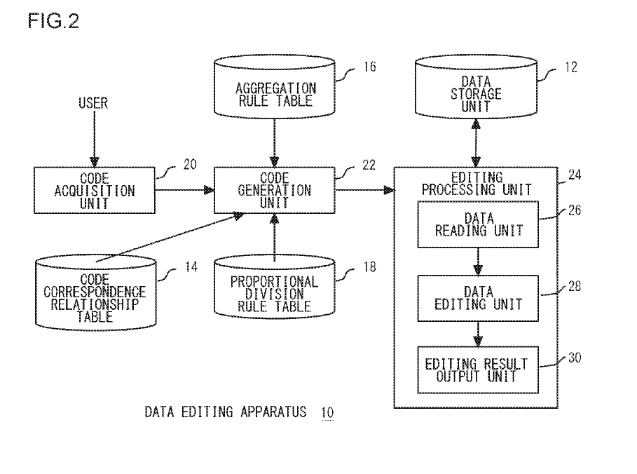

FIG. 2 is a block diagram illustrating a functional configuration of a data editing apparatus 10 according to base technology 2. The data editing apparatus 10 includes a data storage unit 12, a code correspondence relationship table 14, an aggregation rule table 16, a proportional division rule table 18, a code acquisition unit 20, a code generation unit 22, and an editing processing unit 24.

The blocks shown in the block diagram of the specification are implemented in the hardware by any CPU of a computer, other elements, or mechanical devices and in software by a computer program or the like. FIG. 2 depicts functional blocks implemented by the cooperation of hardware and software. Thus, a person skilled in the art should appreciate that there are many ways of accomplishing these functional blocks in various forms in accordance with the components of hardware, software, or the combination of both. For example, the functional blocks of FIG. 2 may be stored in a recording medium as software. The software may be installed in a hard disk of the data editing apparatus 10, read into a main memory of the data editing apparatus 10, and run by a CPU.

The data storage unit 12 is a memory area that stores both data before editing, which is to be edited, and data after the editing. The data storage unit 12 stores a CSV (Comma Separated Values) file associating a data value with a basis for each of the data before the editing and the data after the editing. For example, a line of a CSV file may be “value, the presence of hat, name, unit, time, subject,” and a blank line may indicate a separator of elements. It is obvious that the data storage unit 12 may be provided in an information processing apparatus different from the data editing apparatus 10, for example, inside a database server. In this case, an information processing system may be constructed where the database server and the data editing apparatus 10 are connected via a communication network such as LAN, WAN, the Internet, etc.

The code correspondence relationship table 14 is a memory area that stores a correspondence relationship between a program language for describing data editing details (editing operations) by the intensive notation (hereinafter, also referred to as “intensive notation language”) and a program language for describing data editing details by the extensive notation (hereinafter, also referred to as “extensive notation language”). It is assumed that the extensive notation language according to the embodiment is a Java (registered trademark) language. Alternatively, the extensive notation language may be other program languages such as a C language.

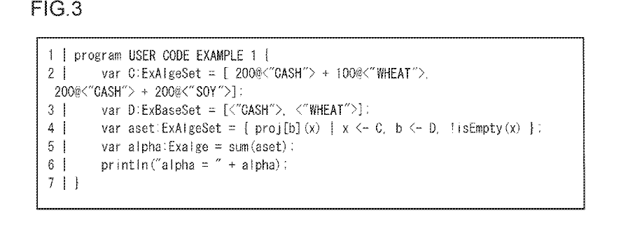

The correspondence relationship between the intensive notation language and the extensive notation language is, for example, association of a keyword indicating an editing operation in the intensive notation language with a code (function) in which logic for realizing the editing operation in the extensive notation language is implemented. More specifically, a description of a condition for extracting specific data from a plurality of pieces of data in the intensive notation language is associated with a description of a repeat order (command) for sequentially listing a plurality of pieces of data in the extensive notation language. For example, the correspondence relationship is association of a code for specifying input data in the intensive notation language with a code in which logic for reading the input data into memory in the extensive notation language is implemented. A specific example of the correspondence relationship will be described later in FIG. 3 through FIG. 6.

The aggregation rule table 16 is a memory area that stores an aggregation rule defining an aggregation relationship between a plurality of types of bases that needs to be referred to at the time of an aggregation operation. The aggregation rule defines, for example, the above-stated aggregation relationship, {Tsugaru, Fuji, Kougyoku}→{apple}. A basis (“apple” in the above example) that aggregates a plurality of types of bases is referred to as “aggregation basis” in the following. The proportional division rule table 18 is a memory area that stores a proportional division rule defining a proportional division rate of a plurality of types of bases that needs to be referred to at the time of a proportional division operation. The proportional division rule defines, for example, the above-stated proportional division relationship, {apple}→{Tsugaru, Fuji, Kougyoku}, and a proportional division rate, 1:1:1.

The code acquisition unit 20 acquires a program code (hereinafter, also referred to as “user code”) that is input by a user via a predetermined input apparatus such as a keyboard. This user code is described in an intensive notation language. A detailed description of a specific example of the user code will follow.

In accordance with the correspondence relationship stored in the code correspondence relationship table 14, the code generation unit 22 generates, based on the user code, a program code (hereinafter, also referred to as “execution code”) in which the data editing details described in the user code are described in an extensive notation language. It is assumed that an execution code according to the embodiment is a Java bytecode. More specifically, the code generation unit 22 generates a Java source code that corresponds to the user code and generates a Java bytecode by compiling the source code. A detailed description of a specific example of the execution code will follow.

In accordance with the execution code generated by the code generation unit 22, the editing processing unit 24 edits data to be edited that is stored in the data storage unit 12. The editing processing unit 24 includes a data reading unit 26, a data editing unit 28, and an editing result output unit 30. Needless to say, the function of the editing processing unit 24 (the data reading unit 26 through the editing result output unit 30) may be achieved by the execution of the execution code in a predetermined execution engine. For example, when the execution code is a Java bytecode, the execution engine is a JVM (Java Virtual Machine).

The data reading unit 26 reads the data to be edited from the data storage unit 12 and generates, based on the data, a data object in which a data value and a basis are associated with each other in the memory. The data editing unit 28 sets editing result data by performing an operation on the data object generated by the data reading unit 26. The editing result output unit 30 records, as a CSV file, the editing result data set by the data reading unit 26 and stores the CSV file in the data storage unit 12.

FIG. 3 illustrates an example of a user code for operating accounting type data. In the following code example, line numbers are shown at the left end, and the position of a code is appropriately shown by the line numbers. Specified as data to be edited in FIG. 3 is a set C containing an element, 200<cash>+100<wheat>, and an element, 200 <cash>+200<soy>. In the figure, the data to be edited is directly input for the purpose of simplifying the figure. Typically, a data object that indicates input data is generated by specifying the name of a CSV file serving as an input file and a position for describing the input data in the CSV file.

Specified in line 4 in FIG. 3 is a projection process of exchange algebra, that is, a projection operation for extracting a subelement that agrees with a specified basis. More specifically, a process is specified, which is a process of extracting, from the set C, an element that corresponds to the basis <cash> or the base <wheat> and that satisfies a condition where a value is already set and assigning the element to a set aset. Specified in line 5 is a process of adding elements in the set aset. Since the set aset includes 200 <cash>, 100<wheat>, and 200<cash>, an addition result alpha is: 400<cash>+100 <wheat>. In the figure, an editing result is output to standard output for the purpose of simplifying the figure. Typically, a CSV file is specified as an output file, and the editing result (in this case, the details of the addition result alpha) is recorded in the CSV file.

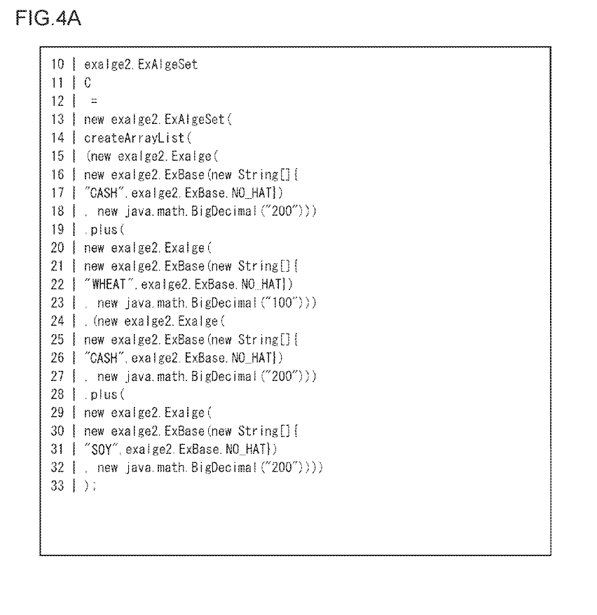

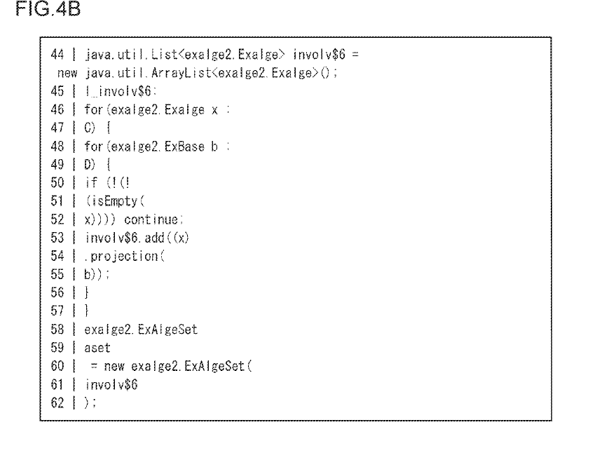

FIG. 4A illustrates an execution code that corresponds to the user code shown in FIG. 3. More specifically, the execution code is an execution code generated by the code generation unit 22 according to line 2 in FIG. 3 and corresponds to a function of the data reading unit 26. In the explanation of the embodiment, a Java source program is shown as the execution code for the sake of convenience. In the figure, an ExAlge object that corresponds to an element, 200<cash>+100<wheat>, (lines 15-23) and an ExAlge object that corresponds to an element, 200<cash>+200<soy>, (lines 24-32) are stored in an ExAlgeSet object that corresponds to the set C.

FIG. 4B illustrates an execution code that corresponds to the user code shown in FIG. 3. More specifically, the execution code is an execution code generated by the code generation unit 22 according to line 4 in FIG. 3 and corresponds to a function of the data editing unit 28. In the figure, a projection method is called in a double loop of a for loop listing ExAlge objects that correspond to a plurality of elements included in a set C and a for loop listing ExBase objects that correspond to a plurality of bases included in a set D, and a result of a projection process is added to a list. A set aset is then set based on the list.

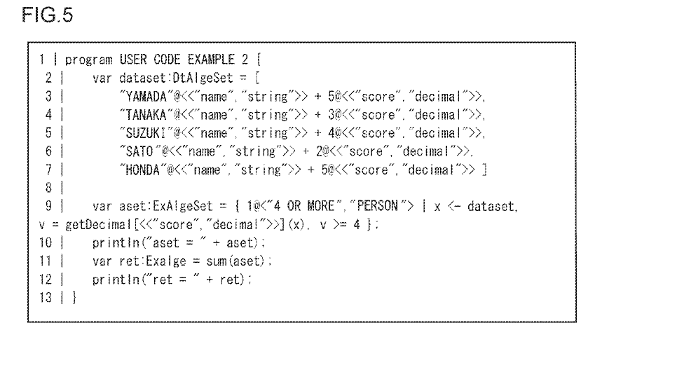

FIG. 5 illustrates an example of a user code for operating record type data. In the figure, a set dataset is specified that includes five elements: Yamada <name>+5<score>; Tanaka <name>+3<score>; Suzuki <name>+4<score>; Sato <name>+2<score>; and Honda <name>+5<score>.

In line 9 in FIG. 5, a process is specified that assigns an element “1<4 or more, person, #, #>” to a set aset whenever there is an element whose value associated with a basis <score> is four or more. Specified in line 11 is a process of adding elements in the set aset. As a result of this, the set aset includes three elements “1<4 or more, person, #, #>,” and “ret=3<4 or more, person, #, #>” is obtained. In other words, this example is directed to totalize the number of people with a score of four or more.

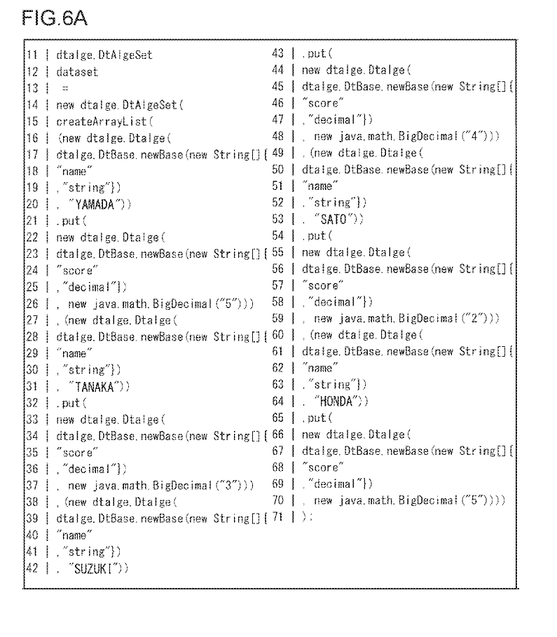

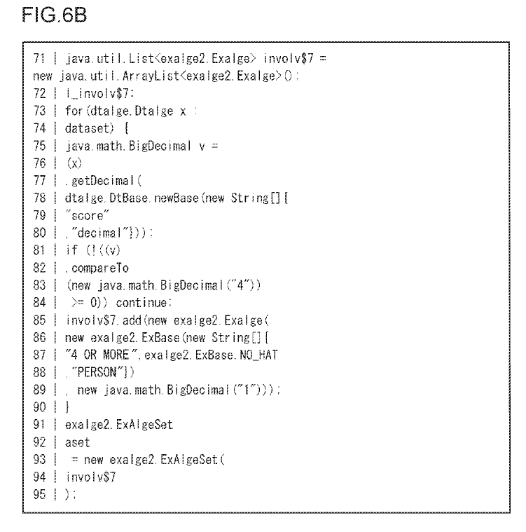

FIG. 6A illustrates an execution code that corresponds to the user code shown in FIG. 5. More specifically, the execution code is an execution code generated by the code generation unit 22 according to lines 2-7 in FIG. 5 and corresponds to a function of the data reading unit 26. In the figure, Dtalge objects that respectively correspond to the above five record type data elements are stored in a DtAlgeSet that corresponds to a set dataset. Various data types are accepted in both a value and a basis for record type data. Thus, information indicating respective data types of a value and a basis are also set for the Dtalge object.

FIG. 6B illustrates an execution code that corresponds to the user code shown in FIG. 5. More specifically, the execution code is an execution code generated by the code generation unit 22 according to line 9 in FIG. 5 and corresponds to a function of the data editing unit 28. In the figure, an element “1<4 or more, person, #, #>” is added to a list when a value that corresponds to a basis <score> is four or more in a for loop listing DtAlgeSet objects that corresponds to a plurality of elements included in a set dataset. A set aset is then set based on the list.

When an aggregation order (function) is set in a user code, the code generation unit 22 generates an execution code for setting an object (hereinafter, also referred to as “intermediate object”) that corresponds to a bookkeeping description in reference to the aggregation rule stored in the aggregation rule table 16. More specifically, the code generation unit 22 calculates a totalization value of a plurality of pieces of data to be aggregated and generates an execution code that sets, as an intermediate object, an object indicating an element that adds up data associating the totalization value with an aggregation basis and data indicating the subtraction of the respective values of the plurality of pieces of data to be aggregated (i.e., data where hat attributes are added to the plurality of pieces of original data to be aggregated). This intermediate object corresponds to F(x) shown in the aggregation in the base technology.

The code generation unit 22 then adds up an object indicating an element where the plurality of pieces of original data to be aggregated are added up and the intermediate object. In other words, by offsetting the plurality of pieces of original data to be aggregated with data where hat attributes are added to the plurality of pieces of original data to be aggregated, the code generation unit 22 generates an execution code for storing, in an object for a totalization result, data associating the totalization value of the plurality of pieces of data to be aggregated with the aggregation basis. It is to be noted here that the totalization result will be hereinafter referred to as “counting result”, “aggregate result”, or “calculated result” also. This execution code corresponds to ˜(x+F(x)) shown in the aggregation in the base technology. The code generation unit 22 may further generate an execution code for outputting the details of the intermediate object to a predetermined file. According to the embodiment, by presenting the details of the intermediate object to a user, efficient debugging can be supported, and information that is usable in transfer calculation for bookkeeping can be provided to the user.

When a proportional division order (function) is set in a user code, the code generation unit 22 first generates an execution code for setting the intermediate object in reference to the aggregation rule stored in the proportional division rule table 18, as in the case of aggregation. More specifically, the code generation unit 22 proportionally divides, in accordance with a proportional division rate, the value of data to be proportionally divided and generates an execution code that sets, as an intermediate object, an object indicating an element that adds up data associating proportionally-divided values with respective bases of a destination of the proportional division and data where hat attributes are added to the original data to be proportionally divided. This intermediate object corresponds to F(x) shown in the proportional division in the base technology.

The code generation unit 22 then adds up an object indicating an element of the original data to be proportionally divided and the intermediate object. In other words, by offsetting the original data to be proportionally divided with data where hat attributes are added to the original data to be proportionally divided, the code generation unit 22 generates an execution code for storing, in an object for a proportional division result, data associating the proportionally-divided values with respective bases of the destination of the proportional division. This execution code corresponds to ˜(x+F(x)) shown in the proportional division in the base technology. The code generation unit 22 may further generate an execution code for outputting the details of the intermediate object to a predetermined file, as in the case of aggregation.

An explanation is given of the operation of the above configuration in the following.

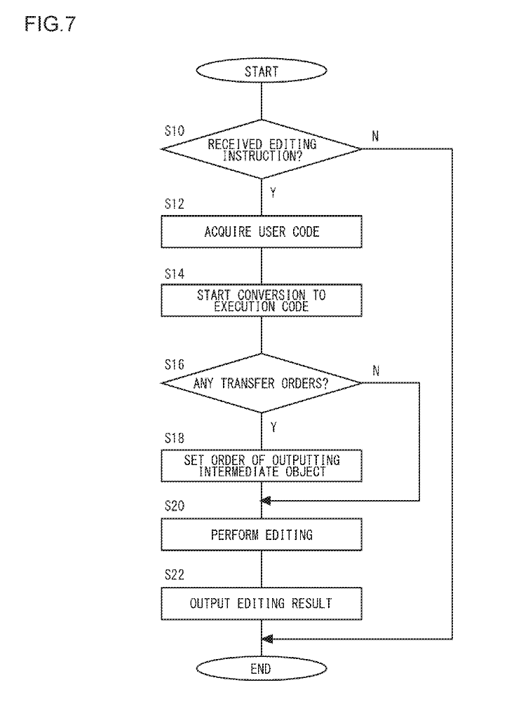

FIG. 7 is a flowchart illustrating the operation of the data editing apparatus 10. The user first describes data editing details using an intensive notation language by intensive notation and inputs a data editing instruction specifying a program code thereof to the data editing apparatus 10. When the data editing apparatus 10 receives the data editing instruction via a predetermined input apparatus (Y of S10), the code acquisition unit 20 of the data editing apparatus 10 acquires, as a user code, the program code input by the user (S12). In accordance with a correspondence relationship between a user code and an execution code stored in the code correspondence relationship table 14, the code generation unit 22 starts a process of generating an execution code based on the user code (S14).

When there is a transfer order such as an aggregation order or a proportional division order in the user code (Y of S16), the code generation unit 22 sets, in the execution code, an order of outputting an intermediate object for an offset process according to the transfer order (S18). When there is no transfer order in the user code (N of S16), S18 is skipped. The editing processing unit 24 performs an editing process on data to be edited in accordance with the execution code that has been generated (S20). For example, the data reading unit 26 reads the data to be edited, which is specified in the user code and the execution code generated based on the user code, from a CSV file for input data storage of the data storage unit 12 and generates a data object. The data editing unit 28 performs an editing operation (such as a projection operation, an aggregation operation, and a proportional division operation based on a basis) specified in the execution code for the data object that has been generated and generates a data object that indicates an editing result. The editing result output unit 30 outputs an editing result by the editing processing unit 24, for example, the details (attribute values) of the data object that has been generated by the data editing unit 28 and that indicates the editing result, to a CSV file for editing result storage of the data storage unit 12 (S22). When the data editing apparatus 10 does not receive any data editing instructions (N of S10), S12 and subsequent steps thereof are skipped.

According to the data editing apparatus 10 of the present embodiment, data that is conventionally treated in an RDB can be expressed as a data object that corresponds to accounting type data or a data object that corresponds to record type data. Thereby, the standardization of data object expression in a computer can be supported. Also, a complicated mechanism such as an RDB is not necessary in the accumulation of data to be edited, and the accumulation can be enabled in a CSV file with high visibility.

The data editing apparatus 10 allows the user to describe data editing details in an intensive notation language. Thus, as long as the user correctly understands the data editing details, the user can achieve correct data editing even when the user does not actually understand an extensive notation language for operating a computer. In the data editing apparatus 10, data to be edited is stored as a combination of a value and a basis. Thus, the user can easily describe editing details, which are based on a basis, by using the intensive notation. Intensive notation is to reflect the specification of data editing without depending on a computer. Thus, the user can achieve correct data editing as long as the user provides a correct specification description. For example, the user needs to describe data editing details according to a specification without paying attention to a for loop or the like. Therefore, inclusion of bugs in a user code can be reduced. In other words, bug generating parts can be easily limited to bugs of the data itself. For example, in an operation of accounting type data, various transfer processes such as aggregation and proportional division can be robustly described.

Even when there is a change in the format (schema) of data, the data editing apparatus 10 allows the range of effects caused by the change to be limited by performing an editing process for a value based on a basis of the data. For example, even when columns in a table storing data to be edited are switched, effects on editing logic in a user code can be eliminated.

Also, the data editing apparatus 10 allows rules for a transfer process, such as aggregation and proportional division, to be stored in a table outside a program code. Thus, even when there is a change in the rules, data of the table needs to be changed, and effects in the program code can thus be eliminated.

As a modification, the data editing apparatus 10 may further comprise a transfer rule table. The transfer rule table is a memory area that stores a transfer rule to be referred to in a transfer operation (it is assumed to be a basis changing operation that does not involve aggregation or proportional division in this case). The transfer rule is data that associates a basis of a transfer source with a basis of a transfer destination. When a transfer order is set in a user code, the code generation unit 22 generates an execution code for setting an intermediate object F(x) in reference to the transfer rule stored in the transfer rule table. For example, when

x=numerical value A<basis of transfer source>,

the following is obtained:

F(x)=numerical value Â<basis of transfer source>+numerical value A<basis of transfer destination>. The code generation unit 22 generates an execution code that corresponds to ˜(x+F(x)). As a result of executing the code, “numerical value A<basis of transfer source>” is changed to “numerical value A<basis of transfer destination>” in the above example.

### Embodiment

Technological innovations such as Machine to Machine (M2M), Internet Of Things (IoT), Internet Of Everything (IoE) have required novel architecture design of industrial infrastructure for manufacturing and service building in a cyber-physical space. We propose a production support system that deals with various information related to systems for manufacturing and service provision in an integrated manner, based on Algebraic Multi-Dimensional Bookkeeping System (AMBS) that gives an exchange algebraic description using article accounts and service accounts in bookkeeping.

Top-down manufacturing and service provision systems for the IoE age envisaged in “Industry 4.0” is exemplified by a scenario that promotes franchising of factories. By way of contrast, the manufacturing support system proposed in the embodiment is characterized by capabilities for constant improvements, bottom-up approach, and autonomous and cooperative nature.

### Summary of the Embodiment

In the age of so-called IoE, there is a growing need for interconnectivity between agents such as autonomous people, articles, software, etc. for management (inclusive of design, implementation, and maintenance) of workflow of article manufacturing and service both inside an organization and across the boundaries of organizations. Currently, information systems that support such management are designed by way of an extension of database solution. Information is managed separately for processes like accounting, price cost management, inventory management, and environment management, production planning.

There is also a need for complicated system implementation and operation in order to let different processes use information in a coordinated manner to carry out production planning, price cost calculation, material flow cost accounting, etc. in an integrated manner. For example, system operation that links database information and ERP software information has been required. Operation that links separately registered data to each other has also been called for. As a result, systems have grown in scale, and maintenance thereof has required much time and money. Also, it has not been easy to revise or improve systems constantly. Another aspect is that introduction of an integrated system (e.g., ERP) for manufacturing is postulated, as in the case of Industry 4.0, for building of systems that take can advantage of supply chains and subcontractor relationship. However, such systems may make difficult manufacturing management that assumes constantly making post facto improvements, which has been one of the sources of corporate competition.

In this embodiment, exchange algebra as an abstraction of bookkeeping is used. An integrated system for coherent, integrated production management in manufacturing and service production is built by using AMBS that uses algebraic representation where real object account/service accounts are accounting bases. The inventive system uses, as a common source, data that records individual tasks constituting processes representative of organizational activities (e.g., finished product production process) in a transaction format according to the AMBS style of description to determine a plurality of types of information for supporting financial accounting, price cost management, environment management, material flow cost accounting, procurement management, production planning, etc.

In this embodiment, tasks like production/provision of articles and services are defined as events, and each event is recorded in a transaction format by using multi-dimensional real bookkeeping that uses real object accounts and service accounts. In other words, transactions in an organization subject to management are described by using exchange algebra as a foundation. More specifically, component information on an article, service, and byproduct resulting from the execution of the task and on a service, source material, etc. put into the task is recorded as transaction information in a double-entry bookkeeping style of description (i.e., journal format) using real object units.

For description of component information of a task, a transaction amount is measured in the double-entry system and by using real object accounts/service accounts. For this reason, environment information with zero price evaluation can be easily described and so are the amount of input material or the time required to provide input service and the operating time of machines, which cannot be subject to price evaluation. Further, not only information indicating input of a material or a product in progress in manufacturing but also input of human service and fabrication service related to the manufacturing can be described as multi-dimensional bookkeeping information in a task event.

A task (synonymous with event) for producing or manufacturing an article may also be referred to as “article production task”, and a task to produce or execute a service may also be referred to as “service task”. A project (critical path) for production of a single article (including manufacturing of a product in progress) or a service service itself, in which the sequence of execution of a plurality of tasks are linked in a partial order relation, is normally represented by information on the relationship between the tasks in terms of the sequence of execution (partial order relation) and on the time required for execution of the tasks. A critical path of manufacturing or service execution itself is also included in a transaction of an individual task in real object bookkeeping.

For this reason, a task sequence for manufacturing or service execution can be built by successively tracking from a given article production task or service task (e.g., an article production task of a finished product) to a task in a previous stage. Similarly, a Bill Of Materials (BOM: also referred to as “component parts sheet” or “deployment of parts sheet”) that shows a process of inputting articles and services in a hierarchical representation, or a Bill Of Services (BOS), a service deployment sheet that is an expanded version of BOM, can also be built. A task in a previous stage is exemplified by task showing a product in progress or a service in the middle of being executed and will hereinafter be referred to as “a task in progress”.

Production instructions and operation information for scheduling can be obtained by learning the time consumed by an input service or operating time of machines in the execution of the tasks in progress forming a critical path of production or service execution. It is also possible to extract, from the information above, management information necessary to allocate resources like production machinery or service personnel to an article production task or service task (information necessary to draft a production instruction manual). If the total volume of resources relevant to the input of service or machine is given separately, it is also possible to create production scheduling information such as a Gantt Chart for production scheduling. The inventor of this disclosure proposes production scheduling information in JP2011-104944.

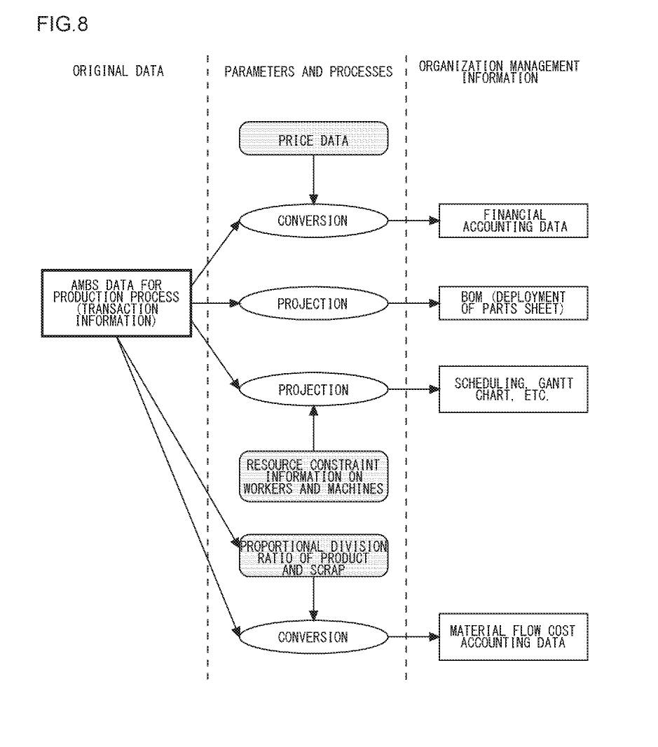

As described above, it is possible to generate a plurality of types of support information to support organization management according to a plurality of schemes, from the transaction information that uses real object bookkeeping. FIG. 8 schematically shows a relationship between the transaction information as original data and the organization management process. The transaction information as illustrated includes a plurality of pieces of transaction data corresponding to a plurality of article production tasks and service tasks forming a production process in an organization. In the “parameters and processes” field of the figure, parameters (e.g., data given from an external source independent of the transaction information) are denoted by shaded rectangles with rounded corners and data processes are denoted by ellipses.

Information related to an input element(s) and an output element(s) in an organizational activity (production process in the example of FIG. 8) is recorded in the transaction information without anything being left out of consideration and recorded as they are in the AMBS style of description. An input element means a source material, product in progress, device, and service put into (used in) the production of an article or service. An output element means an article or service produced as a result of the event. By running an algebraic operation using such transaction information to which exchange algebra is applied as a unified source, it is possible to provide a plurality of types of information for supporting organization management according to a plurality of schemes (hereinafter, referred to as “management support information”). For example, the price cost information for supporting financial accounting can be extracted from the transaction information and provided to the financial accounting system. Alternatively, resource data for resources required for the production of a byproduct (iron scrap, etc.) for supporting material flow cost accounting can be extracted from the transaction information and provided to the material flow cost accounting system.

### Detailed Explanation of the Embodiment

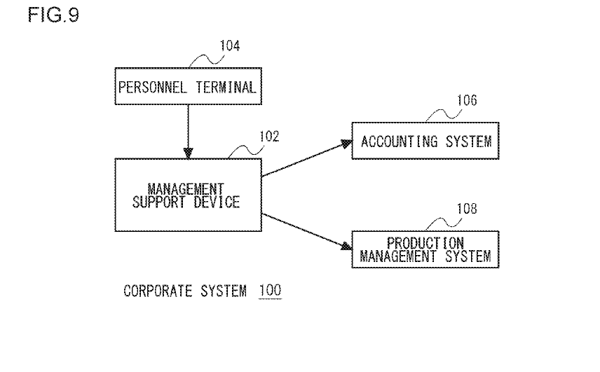

The description below uses a corporate information processing system built for a manufacturing company as an example. The technology described in the embodiment is applicable to information management not only in the manufacturing industry but also in corporations and organizations of a variety of fields and in public institutions. FIG. 9 shows a configuration of a corporate system 100 according to the embodiment. The corporate system 100 is provided with a management support device 102, a personnel terminal 104, an accounting system 106, and a production management system 108. There is no physical limit to the number of devices.

The accounting system 106 performs a data process for financial accounting or material flow cost accounting of a corporation. For example, the accounting system 106 creates a document (financial statements, etc.) for financial accounting or material flow cost accounting. The production management system 108 performs a data process for procurement planning of a source material and for production planning or production management of a product in progress or a finished product. For example, the production management system 108 creates a production plan document based on BOM. The personnel terminal 104 is an information terminal controlled by responsible corporate personnel. For example, the personnel terminal 104 is a PC, tablet terminal, or a smartphone.

The management support device 102 is an information processing device that manages “articles” and “service” in an integrated manner according to multi-dimensional description of transactions using real object/service accounts. In this embodiment, a data processing technology implemented by the management support device 102 and related to manufacturing and service production is mainly described.

The management support device 102 stores information indicating corporate activities (hereinafter, referred to as “event information”) input from the personnel terminal 104 as transaction information in a double-entry bookkeeping format. The management support device 102 uses the transaction information as a common source and generates a plurality of types of management support information for supporting a data process for corporate management using the accounting system 106 and the production management system 108. By providing a plurality of types of management support information to the accounting system 106 and the production management system 108, the management support device 102 improves accuracy, efficiency, and maintainability of corporate management using the accounting system 106 and the production management system 108.

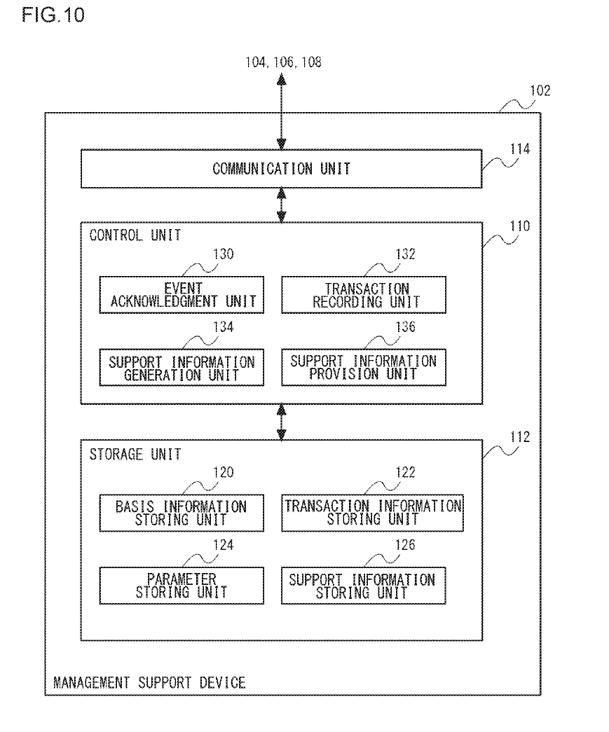

FIG. 10 is a block diagram showing a functional configuration of the management support device 102 of FIG. 9. The management support device 102 is provided with a control unit 110, a storage unit 112, a communication unit 114. The control unit 110 performs various data processes. The storage unit 112 is a storage area referred to by the control unit 110 and storing updated data. The communication unit 114 communicates with an external device according to any of various communication protocols. The control unit 110 exchange data with the personnel terminal 104, the accounting system 106, and the production management system 108 via the communication unit 114.

For example, a computer program including modules corresponding to the functional blocks in the control unit 110 may be stored in a recording medium such as a DVD and installed in a storage of the management support device 102. The functions of the functional blocks in the control unit 110 may be exhibited by causing the processor of the management support device 102 to read the program into the main memory and running the program as appropriate. The functional blocks in the storage unit 112 may be implemented by causing the main memory or storage of the management support device 102 to store data.

The storage unit 112 includes a basis information storing unit 120, a transaction information storing unit 122, a parameter storing unit 124, and a support information storing unit 126. The basis information storing unit 120 stores information related to the basis that should be allocated to each of a plurality of elements (i.e., input elements and output elements) forming an event. For example, the basis information storing unit 120 stores the names of elements and the data for bases (e.g., <painted finished product, piece, #, #>), mapping the names and the data to each other. The basis information storing unit 120 also stores information that defines whether each basis represents a credit side item or a debit side item in double-entry bookkeeping. The basis information storing unit 120 also stores information that defines whether to add “̂” (hat) to the basis in the case the element is an input element, whether to add “̂” in the case the element is an output element, and whether the basis represents a credit side item or a debit side item for each indication that defines whether to add “̂”.

The transaction information storing unit 122 stores transaction information generated by the transaction recording unit 132 described later. The transaction information is double-entry bookkeeping information indicating the numerical quantity of, i.e., quantify, an input element of an event occurring in a corporation in units of quantity for the input element, mapping the input element to a credit side item. The transaction information is also double-entry bookkeeping information indicating the numerical quantity of an output element of an event in units of quantity for the output element, mapping the output element to a debit side item. In reality, the transaction information is data for exchange algebra that is an abstraction of double-entry bookkeeping. It can be said that the transaction information is information indicating elements constituting an event in the journal format.

The parameter storing unit 124 stores parameter information referred to when management support information is generated from the transaction information. The parameter information includes the price and resource constraint information for the elements constituting an event. The resource constraint information indicates, for example, the upper limits of the numbers of workers and machines and the operating time of workers and machines. It can be said that the parameter information defines a criterion or a variable for converting the transaction information into the management support information. The parameter information is configured at a desired point of time by corporate personnel. Typically, the latest parameters are configured before generating management support information.

The support information storing unit 126 stores the plurality of types of management support information generated by a support information generation unit 134 described later.

The control unit 110 includes an event acknowledgment unit 130, a transaction recording unit 132, a support information generation unit 134, and a support information provision unit 136. The event acknowledgment unit 130 acknowledges event information from the personnel terminal 104, the event information including the numerical quantity of an input element constituting an event occurring in a corporation and the numerical quantity of an output element constituting the event. For example, the event information includes (1) the name of each element, (2) information indicating whether the element is an input element or an output element, and (3) the numerical quantity of each element.

When the event acknowledgment unit 130 acknowledges event information, the transaction recording unit 132 identifies, for each of the plurality of elements included in the event information a basis, from among the bases stored in the basis information storing unit 120, corresponding to the element. For each element, the transaction recording unit 132 generates an item in which the basis (or the basis and “A”) is added to the numerical quantity, and generates, as transaction information, exchange algebraic data (accounting data of the base technology) linking element-by-element items with “+”. The transaction recording unit 132 stores the generated transaction information in the transaction information storing unit 122.

In accordance with the transaction information stored in the transaction information storing unit 122 and the parameter information stored in the parameter storing unit 124, the support information generation unit 134 generates the plurality of types of support information for supporting organization management according to a plurality of schemes. The plurality of types of support information include information for supporting financial accounting, information for supporting material flow cost accounting, and information supporting formulation of procurement planning and production planning. Details will be described later. The support information generation unit 134 stores the plurality of support information thus generated in the support information storing unit 126. The support information provision unit 136 transmits each of the plurality of types of support information stored in the support information storing unit 126 to the accounting system 106 or the production management system 108.

The support information generation unit 134 may generate or update management support information periodically at a predetermined timing schedule (e.g., on the first day of the month, every ten days, etc.) in accordance with the latest event information and parameter information. Further, the support information generation unit 134 may generate management support information in response to a request from the personnel terminal 104, the accounting system 106, or the production management system 108. Further, the support information generation unit 134 may generate management support information in response to an input of the latest event information. The support information provision unit 136 may transmit the latest management support information periodically according to a predefined timing schedule. Further, the support information provision unit 136 may transmit the latest management support information when the management support information is updated. Further, the support information provision unit 136 may transmit management support information in response to a request from the personnel terminal 104, the accounting system 106 or the production management system 108.

The event information may be recorded in a CSV file and input to the management support device 102. The transaction information may also be recorded in a CSV file corresponding to the transaction information storing unit 122. When the transaction recording unit 132 and the support information generation unit 134 process transaction information, the transaction information may be loaded in the memory as a Java object.

A description will be given of the operation according to the configuration described above.

1. Recording of a Production Task and a Service Task in Multi-Dimensional Bookkeeping

A series of processes (project) for manufacturing a painted product as a finished product is considered. Specifically, individual tasks constituting a manufacturing path of a painted product are defined as manufacturing events and characterized as double-entry bookkeeping transactions using real object accounts/service accounts. In other words, a task as a unit of production of an article or execution of service is recognized as an event that forms a project execution unit related to the production or service, and the event is recorded as a transaction using real object accounts and service accounts.

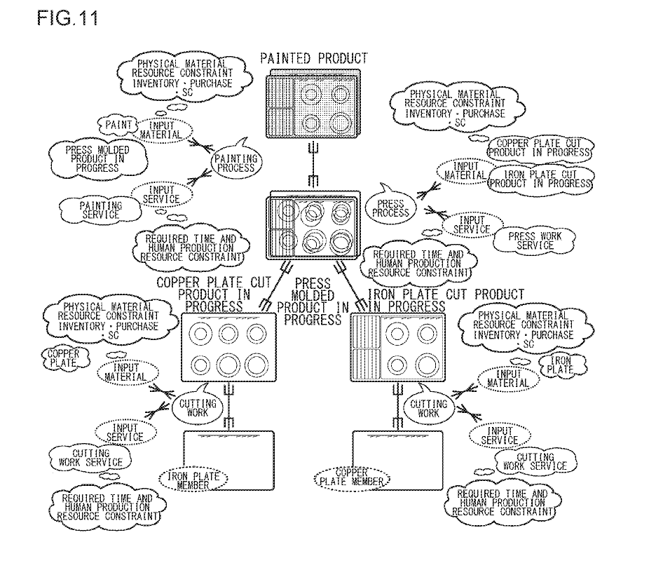

FIG. 11 schematically shows a process of manufacturing a painted product. More specifically, an iron plate material and a copper plate material are purchased at the start. A copper plate cut product in progress and an iron plate cut product in progress are produced by cutting the materials. Subsequently, a press molded product in progress is produced by press working the two products in progress. Finally, the painted product is produced by painting the press molded product in progress. The painted product represents a part in a larger supply chain but is regarded as an end product in the production process of a corporation assumed now.

As shown in FIG. 11, a series of processes for producing a painted product is formed by four events (tasks) including production of an iron plate cut product in progress, production of a copper plate cut product in progress, production of a press molded product in progress, and production of a painted product. Personnel in a corporation inputs these four pieces of event information in the management support device 102 via the personnel terminal 104. In these pieces of event information, the numerical quantity of an input element and an output element is described in units of quantity for the respective elements (i.e., units not converted into price and used in ordinary measurement).

For example, in the event information on the production of an iron plate cut product in progress, 20 Kg of iron material and two 2 hours of cutting work service are defined as input elements, and 1 piece of iron plate cut product in progress and 5 Kg of iron scrap are defined as output elements. Further, in the event information on the production of a copper plate cut product in progress, 8 Kg of copper material and 1 hour of cutting work service are defined as input elements, and 1 piece of copper plate cut product in progress and 2 Kg of copper scrap are defined as output elements. Further, in the event information on the production of a press molded product in progress, 1 piece of iron plate cut product, 1 piece of copper plate cut product in progress, and 1 hour of press work service are defined as input elements, and 1 piece of press molded product in progress is defined as an output element. Further, in the event information on the production of a painted product, 1 piece of press molded product in progress, 2 Kg of paint, and 1 hour of painting service are defined as input elements, and 1 piece of painted product is defined as an output element.

When the event acknowledgment unit 130 of the management support device 102 acknowledges these items of event information, the transaction recording unit 132 records transaction information that represents the items of event information in exchange algebra using real object accounts. More specifically, the transaction recording unit 132 records transaction information in which the basis stored in the basis information storing unit 120 and corresponding to the name of the element and the input/output type is added to the input element and the output element. The transaction information recorded herein is a description of a transaction from the perspective of the constraint on physical material resources and is referred to as “article transaction information”.

Four pieces of article transaction information A1˜A4 corresponding to the four events described above will be shown below.

(A1) Transaction information corresponding to the event of production of an iron plate cut product in progress:

x[production of iron plate cut product in progress]

=1<iron plate cut product in progress, piece, #, #>

+5<iron scrap, Kg, #, #>

+20^<iron material, Kg, #, #>

+2^<cutting work service, hour, #, #>

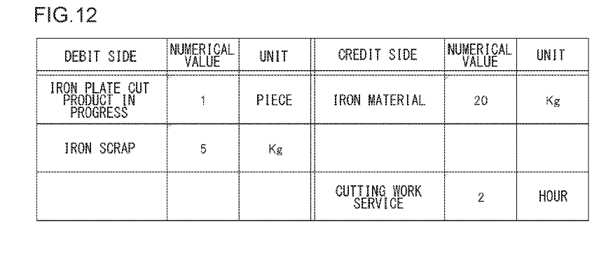

This shows a transaction in which 1 piece of iron plate cut product in progress and a byproduct of 5 Kg of iron scrap are produced by practicing a cutting work for 2 hours using 20 Kg of iron plate material as a source material. FIG. 12 shows an example of table representation in double-entry bookkeeping. The figure shows the transaction information on the production of an iron plate cut product in progress in a table format. From the perspective of double-entry bookkeeping, the iron material and the cutting work service that are input elements are on the credit side, and the iron plate cut product in progress and the iron scrap that are output elements are on the debit side. The debit side and the credit side do not balance out at the stage of real object description but they balance out when valuated in money, inclusive of the profit and loss.

(A2) Transaction information corresponding to the event of production of a copper plate cut product in progress:

x[production of copper plate cut product in progress]

=1<copper plate cut product in progress, piece, #, #>

+2<copper scrap, Kg, #, #>

+8^<copper material, Kg, #, #>

+1^<cutting work service, hour, #, #>

This shows a transaction in which 1 piece of copper plate cut product in progress and a byproduct of 2 Kg of copper scrap are produced by practicing a cutting work for 1 hour using 8 Kg of copper plate material as a source material.

(A3) Transaction information corresponding to the event of production of a press molded product in progress:

x[production of press molded product in progress]

=1<press molded product in progress, piece, #, #>

+1^<iron plate cut product in progress, piece, #, #>

+1<iron scrap, Kg, #, #>

+1^<copper plate cut product in progress, piece, #, #>22

+1^<press work service, hour, #, #>

This shows a transaction in which 1 piece of press molded product in progress is produced by press working 1 piece of iron plate cut product in progress and 1 piece of copper cut product in progress for 1 hour.

(A4) Transaction information corresponding to the event of production of a painted product:

x[production of painted product]

=1<painted product, piece, #,#>

+1^<press molded product in progress, piece, #,#>

+2^<paint, Kg, #,#>

+1^<painting service, time, #,#>

This shows a transaction in which 1 piece of painted product is produced by practicing a painting service using 1 piece of press molded product in progress and 2 Kg of paint as source materials.

In these four pieces of article transaction information, production and work events involving source materials and products in progress are described as transactions in multi-dimensional bookkeeping using real object accounts. This is equivalent to recognizing a manufacturing task as Point Of Event (POE) data describing it in the double-entry bookkeeping style. The article transaction information is described as a transaction including two types of input items (i.e., input elements), i.e., (1) input of a material or a product in progress, (2) input of a service that works or uses the material, and two types of yield items (i.e., output elements), i.e., (3) production of a finished product or a product in progress, and (4) and production of a byproduct.

In this embodiment, the service that actually works a material or a product in progress is dealt with as a service input measured in units of time. Transaction information indicating a relationship between inputs of capital goods such as machinery, personnel, energy necessary for execution of the service and the time constraint, etc. on the service that uses the capital goods for production (hereinafter, referred to as “service transaction information”) is described and managed separately from the article transaction information. In essence, a transaction in an event related to an input of a physical material such as a source material and a transaction in an event related to a service to process a physical material such as a source material are discriminated and described accordingly in this embodiment.

In this exemplary case, (1) cutting work service, (2) press work service, and (3) painting service are work service tasks input in units of time in the series of manufacturing processes. Personnel in a corporation inputs these three types of event information in the management support device 102 via the personnel terminal 104. These items of event information also indicate the numerical quantity of the input element and the output element in units of quantity for the respective elements.

For example, in the event information on a cutting work service, 2.5 KWh of electricity, 0.2 hours of labor service, and 1 hour of cutting machine usage service are defined as input elements, and 1 hour of cutting work service and 12.9 Kg of carbon dioxide are defined as output elements. Further, in the event information on a press work service, 10 KWh of electricity, 1 hour of labor service, and 1 hour of press machine usage service are defined as input elements, and 1 hour of press work service and 10 Kg of carbon dioxide are defined as output elements. Further, in the event information on a painting service, 4 L (liter) of groundwater and 1 hour of labor service are defined as input elements, and 1 hour of painting service and 0.01 Kg of contaminant are defined as output elements.

When the event acknowledgment unit 130 of the management support device 102 acknowledges these items of event information, the transaction recording unit 132 records service transaction information that represents the items of event information in exchange algebra using service accounts. More specifically, the transaction recording unit 132 records service transaction information in which the basis stored in the basis information storing unit 120 and corresponding to the name of the element and the input/output type is added to the input element and the output element. The service transaction information can be said to be a description of a transaction of work service from the perspective of the required time and the constraint on resources (manpower, machines, etc.).

Three pieces of service transaction information B1˜B3 corresponding to the three service events described above will be shown below. These items of service transaction information indicate the detail of fabrication service per a unit time. Meanwhile, an input of a fabrication service of a necessary period of time is recorded in the article transaction information shown in A1˜A4. The cutting work service shown in B1 is used both in the production of an iron plate cut product in progress of A1 and the production of a copper plate cut product in progress of A2.

(B1) Transaction information corresponding to the event of cutting work service

x[unit cutting work service]

=1<cutting work service, time, #, #>

+2.5^<electricity, KWh, #, #>

+12.9<CO₂, Kg, #, #>

+0.2^<labor service, time, #, #>

+1^<cutting machine usage service, time, #, #>

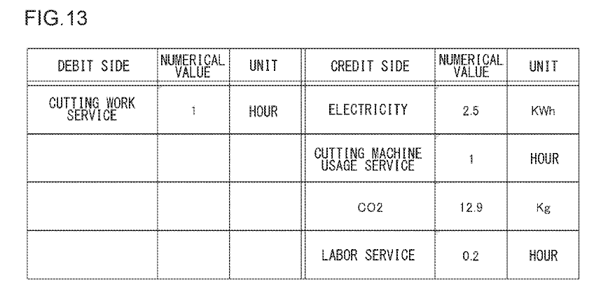

This shows a transaction in which the cutting machine is operated for 1 hour consuming 2.5 KWh of electricity, a person works for 0.2 hours, and 12.9 Kg of carbon dioxide is discharged in order to provide a unit time of 1 hour of cutting work service. FIG. 13 shows an example of table representation in double-entry bookkeeping. The figure shows transaction information on a cutting work service in a table format. From the perspective of double-entry bookkeeping, the electricity, cutting machine usage service, and labor service that are input elements are on the credit side, and the cutting work service that is an output element is on the debit side. Carbon dioxide as an output element represents bads (goods having a negative value and, stated otherwise, an item equivalent to a debt) and so should appear on the credit side. The same holds true of the contaminant of B3 described later. The debit side and the credit side of the service transaction information do not balance out at the stage of real object description, either, but they balance out when valuated in money, inclusive of the profit and loss. If it is not possible to determine whether an output element represents bads when recording the transaction information, the output element may be temporarily recorded as a byproduct and transferred to bads post facto.

As regards labor service, a labor service produced in exchange for a labor debt in the form 0.2<labor service, time, #, #>+0.2<labor debt, time, #, #> is assumed to be input to the transaction of generating a cutting work service. In contrast with the ordinary practice of paying labor cost as an indirect cost item, this represents price cost calculation in which an item input to provide a labor service is clarified. The same is true of machinery. In contrast with an indirect method of depreciation whereby the provision for depreciation is earmarked to correspond to the depreciation expense as an indirect cost (the provision for depreciation is earmarked as a debt), it is assumed here that a cutting machine usage service is generated in the form 1<cutting machine usage service, time, #, #>+1<provision for depreciation of cutting machine, time, #, #> and input to the cutting work service. It should be noted that the cutting work service itself and the cutting work service usage service as a price cost item that should be input to produce the cutting work service are separate.

(B2) Transaction information corresponding to the event of press work service

x[unit press work service]

=1<press work service, time, #, #>

+10^<electricity, KWh, #, #>

+10^<CO₂, Kg, #, #>

+1^<labor service, time, #, #>

+1^<cutting machine usage service, time, #, #>

(B3) Transaction information corresponding to the event of painting service

x[unit painting service]

=1<painting service, time, #, #>

+4^<groundwater, L, #, #>

+0.01^<contaminant, Kg, #, #>

+1^<labor service, time, #, #>

In the service transaction information B1˜B3, the constraint on resources other than physical materials (e.g., materials related to production) is described. For example, the maximum time constraint on the task and the constraint on the capital such as personnel, mechanical devices, etc. for the execution of the task are described. Thus, according to this embodiment, a portion related to an input of a material (article transaction information) and a service portion necessary to work the material (service transaction information) are recorded as separate transactions. This enables integrated extraction of constraining requirements such as information on the procurement of a source material or a product in progress or mutual relationship therebetween (e.g., BOM), time-related information such as a schedule of work (e.g., service flow information described later), or the like. Details will be described later.

2. Derivation of Various Data from the Core of Real Object Transaction Data:

As described above, the transaction recording unit 132 records the POE data of various tasks related to corporate activities as transaction information in the double-entry bookkeeping format, using the real object basis. The support information generation unit 134 extracts various data necessary for management of service provision or management of article production (i.e., management support information) based on the recorded transaction information and the parameters such as price information. The parameters need not be defined at the point of time of recording the transaction information but may be defined until the point of time of generating the management support information.

2-1. Extraction of Financial Accounting Information and Price Cost Management Information:

By converting the transaction information (A1˜A4) based on the real object accounts of the four pieces of POE information as production and work tasks and the transaction information (B1˜B3) of the three work service tasks input in the production and work tasks into cash value, ordinary financial accounting information and basic price cost calculation information using the financial accounting information can be obtained. The transaction recording unit 132 generates information indicating the price cost of the output elements in the transaction information as support information, by converting the numerical quantity of the input element indicated in the transaction information in units of quantity for the input element into a representation in units of money in accordance with the price information of the input element stored in the parameter storing unit 124. The transaction recording unit 132 stores the generated support information in the support information storing unit 126.

It is assumed here that the electric rate, copper material price, iron material price, labor service price (i.e., labor expense), cutting machine usage service price, press machine usage service price, usage fee of groundwater, and paint price are given as follows. More specifically, price information that defines the following correspondence between a multi-dimensional description included in the original transaction information (left item) and a cash-based description (right item) is stored in the parameter storing unit 124. c1˜c8 denote prices in units of Japanese yen. The basis information storing unit 120 also stores the bases in units of money shown below and also stores information indicating whether each basis in units of money is a credit side item or a debit side item when provided with “̂” and when not provided with “̂”, respectively.

T1=1<electricity,KWh,#,#>−>c1<electricity,yen,#,#>

T2=1<copper material,Kg,#,#>−>c2<copper material,yen,#,#>

T3=1<iron material,Kg,#,#>−>c3<iron material,yen,#,#>

T4=1<labor service,time,#,#>−>c4<labor service,yen,#,#>

T5=1<cutting machine usage service,time,#,#>−>c5<cutting machine usage service,yen,#,#>

T6=1<press machine usage service,time,#,#>−>c6<press machine usage service,yen,#,#>

T7=1<groundwater,L,#,#>−>c7<groundwater,yen,#,#>

T8=1<paint,Kg,#,#>−>c8<paint,yen,#,#>

The support information generation unit 134 generates the following transfer transaction data in accordance with the above price information. In the following expressions, “a” denotes an input amount or input time.

T1(a)=â<electricity,KWh,#,#>+a×c1<electricity,yen,#,#>

T2(a)=â<copper material,Kg,#,#>+a×c2<copper material,yen,#,#>

T3(a)=â<iron material,Kg,#,#>+a×c3<iron material,yen,#,#>

T4(a)=â<labor service,time,#,#>+a×c4<labor service,yen,#,#>

T5(a)=â<cutting machine usage service,time,#,#>+a×c5<cutting machine usage service.yen,#,#>

T6(a)=â<press machine usage service,time,#,#>+a×c6<press machine usage service,yen,#,#>

T7(a)=â<groundwater,L,#,#>+a×c7<groundwater,yen,#,#>

T8(a)=â<paint,Kg,#,#>a×c8<paint,yen,#,#>

In ordinary financial accounting and price cost calculation, contaminants and carbon dioxide are left out of consideration as being of zero valuation but can, however, be used as information in making calculations of environment bookkeeping. Further, the usage fee of groundwater in this case is calculated by assuming that it is procured internally instead of being procured from an external source. Further, a cross-trained worker is assumed, and the labor cost is calculated uniformly. Further, information on the byproducts of copper scrap and iron scrap is used in material flow cost accounting. If the sales price or processing cost thereof is zero, the information can be left out of consideration in financial accounting.

For simplicity, it is assumed that contaminants, carbon dioxide, copper scrap, and iron scrap can be left out of consideration as being of priced at zero. The support information generation unit 134 generates the following transfer transaction data.

Q1(a)=â<CO₂,Kg,#,#>+O<CO₂,yen,#,#>

Q2(a)=â<contaminant,Kg,#,#>+0<contaminant,yen,#,#>

Q3(a)=â<iron scrap,Kg,#,#>+0<iron scrap,yen,#,#>

Q4(a)=â<copper scrap,Kg,#,#>+0<copper scrap,yen,#,#>

Further, the support information generation unit 134 generates the following transfer transaction data for transferring from the multi-dimensional basis (i.e., physical quantity basis) of the article or service subject to price cost calculation into a cash basis. More specifically, a transfer calculation expression for transferring the unit of main output elements (excluding scrap and bads) in the transaction information into cash. α, β, γ in the following expressions denote the price cost of the cutting work service, press work service, painting service (the price per unit time). Further, δ[iron plate cutting], δ[copper plate cutting], δ[press], and δ[painting] denote the price cost (the price per unit quantity) of an iron plate cut product in progress, copper plate cut product in progress, press molded product in progress, and painted product.

R[cutting work service](a)=â<cutting work service,time,#,#>+a×α<cutting work service,yen,#,#>

R[press work service](a)=â<press work service,time,#,#>+a×β<press work service,yen,#,#>

R[painting service](a)=â<painting service,time,#,#>a×γ<painting service,yen,

R[iron plate cut product in progress](a)=â<iron plate cut product in progress,piece,#,#>+a×δ[iron plate cutting]<iron plate cut product in progress,yen,#,#>

R[copper plate cut product in progress](a)=â<copper plate cut product in progress,piece,#,#>+a×δ[copper plate cutting]<copper plate cut product in progress,yen,#,#>

R[press molded product in progress](a)=â<press molded product in progress,piece,#,#>+a×δ[press]<press molded product in progress,yen,#,#>

R[painted product](a)=â<painted product,piece,#,#>+a×δ[paint]<painted product,yen,#,#>

The support information generation unit converts each of the article transaction information and service transaction information into a presentation in units of money in accordance with the above transfer transaction data.

x[unit cutting work service: yen]=˜{x[unit cutting work service]+R [cutting work service](1)+^T1(2.5)+Q1(12.9)+^T4(0.2)+^T5(1)}=˜{1<cutting work service, time, #, #>2.5^<electricity, KWh, #, #<+12.9>CO₂, Kg, #, #>+0.2^<labor service, time #, #>

+1^<cutting machine usage service, time, #, #>+1^<cutting work service, time #, #>+α<cutting work service, yen, #, #>

+2.5<electricity, KWh. 190 , #>+2.5cl^<electricity, yen, #, #>

+12.9^<CO₂, Kg, 190 , #>+0.2<CO₂, yen, #, #>

+0.2<labor service, time, #, #>+0.2c4^<labor service, yen, #, #>

+1<cutting machine usage service, time #, #>+c5^<cutting machine usage service, yen, #, #>

=α<cutting work service, yen 190 , #>+2.5cl^<electricity, yen, #, #>+0.2c4^<labor service, yen, #, #>+c5^<cutting machine usage service, yen, #, #>

The basis “<cutting work service, yen #, #>” is a debit side item, and the bases “<electricity, yen, #, #>”, “<labor service, yen, #, #>”, and “<cutting machine usage service, yen, #, #>” are credit side items, and the credit side items and the debit side items balance out. Therefore, the support information generation unit 134 derives the price cost of the cutting work service per a unit time (1 hour in this case) as follows.

α=2.5c1+0.2c4+c5

Since c1, c4, and c5 are given values, the value of a, which is the price cost of the cutting work service per 1 hour, is determined. The same is true of the other articles and services.

More specifically, the support information generation unit 134 derives the price cost of the press work service and painting service per a unit time (1 hour in this case) as follows.

x[unit press work service: yen]=˜{x[unit press work service]+R[press work service](1)+^T1(10)+Q1(10)+^T4(1)+^T6(1)}

=β<press work service, yen, #, #<+10cl<electricity, yen #, #>+c4^<labor service, yen, #,#>+c6^<press machine usage service, yen, #, #>

Accordingly, β=10c1+c4+c6 is derived.

$$\begin{matrix}x [ unit painting service \text{:} yen ] = \text{\textasciitilde} \{ x [ unit painting service ] \text{+} \\ R [ painting service ] ( 1 ) \text{+} \text{\textasciicircum} T 7 ( 4 ) \text{+} \\ Q 2 ( 0.01 ) \text{+} \text{\textasciicircum} T 4 ( 1 ) \} \\ = γ \text{<} painting service , yen , \# , \# \text{>} \text{+} \\ 4 c 7 \hat{} \text{<} groundwater , yen \# , \# \text{>} \text{+} \\ c 4 \hat{} \text{<} labor service , yen , \# , \# \text{>}\end{matrix}$$

Accordingly, γ=4c7+c4 is derived.

The support information generation unit 134 then derives the price cost of the product in progress and the finished product as follows in accordance with the price cost of the services.

x[production of iron plate cut product in progress: yen]

=˜{x[production of iron plate cut product in progress]+R[iron plate cut product in progress](1)+Q3(5)+T3^(20)+^R[cutting work service](2)}

=δ[iron plate cutting]<iron plate cut product in progress, yen, #,#>+20c3^<iron material, yen, #, #>2α^<cutting work service, yen, #, #>

Accordingly, δ[iron plate cutting]=20c3+2α is derived. In other words, 5c1+20c3+0.4c4+2c5 is derived as the price cost of the iron plate cut product in progress.

x[production of copper plate cut product in progress:yen]

=˜{x[production of copper plate cut product in progress]+R[copper plate cut product in progress](1)+Q4(2)+T2̂(8)+̂R[cutting work service](1)}

=δ[copper plate cutting]<copper plate cut product in progress,yen,#,#>+8c2̂<copper material,yen,#,#>+α̂<cutting work service,yen,#,#>

Accordingly, δ[copper plate cutting]=8c2+a is derived. In other words, 2.5c1+8c2+0.2c4+c5 is derived as the price cost of the copper plate cut product in progress.

Where a product in progress is an input element, the product in progress is also converted into cash by adding the transfer transaction data of the product in progress with “̂”.

x[production of press molded product in progress:yen]

=˜{x[production of press molded product in progress]+R[press molded product in progress}(1)+̂R[iron plate cut product in progress](1)+̂R[copper plate cut product in progress](1)+̂R[press work service](1)}

=δ[press]<press molded product in progress,yen, #,#>+δ[iron plate cutting]̂<iron plate cut product in progress,yen,#,#>+δ[copper plate cutting]̂<copper plate cut product in progress,yen,#,#>+β̂<press work service,yen,#,#>

Accordingly, δ[press]=δ[iron plate cutting]+δ[copper plate cutting]+β is derived. In other words, 17.5C1+8c2+20c3+1.6c4+3c5+c6 is derived as the price cost of the press molded product in progress.

x[production of painted product: yen]

=˜{x[production of painted product]+R[painted product](1)+^R[press molded product in progress](1)+^T8(2)+^R[painting service](1)}

=δ[painting]<painted product, yen, #,#>+δ[press]^<press molded product in progress, yen, #,#>+2c8^<+y^painting service, yen, #, #>

Accordingly, δ[paint]=δ[press]+2c8+γ is derived. In other words, 17.5c1+8c2+20c3+2.6c4+3c5+c6+4c7+2c8 is derived as the price cost of the painted product.

The support information generation unit 134 stores the price cost information on the article and the service thus derived in the support information storing unit 126. When a predetermined condition for provision is met, the support information provision unit 136 provides the price cost information on the article and the service to the accounting system 106. The accounting system 106 uses the price cost information on the article and the service to perform a financial accounting process and create financial statements.

Thus, the AMBS style of description (i.e., transaction information), using the real basis, of the manufacturing task and the work service task used in the manufacturing task can be easily converted into an ordinary cash-based description by performing a transferring operation based on the price information. By recording an event in the AMBS style of description using the real object basis, scenario analysis related to price change can be easily made. Further, the inventive approach can easily address a variety of different scenarios including the price for processing bads, price of a byproduct, etc.

By starting with a cash-based description, on the other hand, information on elements valuated at zero and elements for which it is not fit to indicate the price are left out of consideration. It is also not easy to return from a cash-based description to a physical description (a description on a real object basis). In the related-art double-entry bookkeeping, a cash-based description has been basically used to create an apparent balance between the debit side and the credit side. However, the balance between the debit side and the credit side can be defined post facto for individual events (transactions). It is therefore far more flexible and versatile to employ a multi-dimensional bookkeeping description at the source of information. Further, by algebraically describing multi-dimensional bookkeeping using exchange algebra, various calculations can be easily formulated algebraically and dealt with accordingly without the constraint associated with the table format. The calculations can be successively executed in a dataflow style by starting with upstream data so that it is not necessary to manage complicated tables on a huge database.

2-2. Extraction of Material Flow Cost Accounting Information

Material flow cost accounting (hereinafter, also referred to as “MFCA”) has been highlighted as a special form of managerial accounting for, for example, managing waste of materials in a production process. In MFCA, the value of a product is evaluated with a criterion different from that of price cost calculation in financial accounting.

For example, the price cost of a portion of waste (e.g., scrap) is not assessed in ordinary cost price calculation. In MFCA, on the other hand, where a scrap is created as a byproduct in producing a product, the proportion of the material used for the product relative to that of the scrap is determined in terms of weight. The proportion is then used to proportionally dividing inputs of various services used in the production into a portion used to produce a main product and a portion used to produce the scrap. This is directed to the purpose of understanding and managing the waste of scrap created in the production process as a waste of the service input to the production process. In essence, the price cost input to the production according to MFCA is, in principle, an indicator in strategic accounting for clarifying the waste of scrap.

The support information generation unit 134 generates, as management support information, information indicating the numerical quantity of an input element used in producing a byproduct, by proportionally dividing the numerical quantity of the input element indicated by the service transaction information according to the proportion of the article produced (i.e., the main product) relative to that of the byproduct indicated by the article transaction information. The support information generation unit 134 stores the generated information in the support information storing unit 126.

In this exemplary case, an MFCA calculation is performed for the event of production of an iron plate cut product in progress and a copper plate cut product in progress in which the scraps are created. First, the support information generation unit 134 determines the weights of input source materials Input[iron] and Input[copper] from the article transaction information on the iron plate cut product in progress and the copper plate cut product in progress by means of a projection operation and a norm operation of exchange algebra. An injection operation is denoted by “Pro” hereinafter. A norm operation in this case is a calculation to determine an absolute value. In the event information and the transaction information, information indicating whether the input element is a source material may be added to each input element, and information indicating whether the output element is a main product or a byproduct may be added to each output element. These types of information may be determined by personnel in advance and stored in the transaction information storing unit 122.

Input[iron]
=|Pro[^{∧}<iron material, Kg, #, #>](x[production of iron plate cut

product in progress])|

=|20^{∧}<iron material, Kg, #, #>|
=20
Input[copper]
=|Pro[^{∧}<copper material, Kg, #, #>](x[production of copper plate cut

product in progress])|

=|8^{∧}<copper material, Kg, #, #>|
=8

Next, the support information generation unit 134 determines the weights of the scraps waste[iron] and waste[copper] from the article transaction information on the iron plate cut product in progress and the copper plate cut product in progress by means of a projection operation and a norm operation of exchange algebra.

Waste[iron]
=|Pro[^{∧}<iron scrap, Kg, #, #>](x[production of iron plate cut product
in progress])|
=|5<iron scrap, Kg, #, #>|
=5
Waste[copper]
=|Pro[^{∧}<copper scrap, Kg, #, #>](x[production of copper plate cut

product in progress])|

=|2^{∧}<copper scrap, Kg, #, #>|
=2

The support information generation unit 134 then determines the weights of the source materials product_use[iron] and product_use[copper] resulting in the product by referring to the difference between the input weight and the scrap weight.

product_use[iron]=Input[iron]−Waste[iron]=15

product_use[copper]=Input[copper]−Waste[copper]=6

The support information generation unit 134 determines a proportion between the weight of the source material used for the product and the weight used for the scrap. In the case of iron, the proportion is 15:5 and, in the case of copper, 6:2. The support information generation unit 134 identifies this proportion as a proportional division ratio related to the service. The support information generation unit 134 identifies ¾:¼ as a proportional division ratio in the case of iron, and ¾:¼ in the case of copper.

In this case, the cutting work service is subject to proportional division. The support information generation unit 134 proportionally divides the cutting work service used in the event of production of an iron plate cut product in progress into the service for producing an iron plate cut product in progress and the service for producing the iron scrap in accordance with the proportional division ratio. Hereinafter, the former will be denoted by x[iron plate cutting work service: product] and the latter will be denoted by x[iron plate cutting work service: scrap].

First, the hour of use of the cutting work service in the event of production of an iron plate cut product in progress is extracted.

Hour of use[cutting work service]
=|Pro[^{∧}<cutting work service, time, #, #>](x[production of iron

plate cut product in progress])|

=|2^{∧}<cutting work service, time, #, #>|=2
x[iron plate cutting work service: product]
=¾×hour of use[cutting work service]×x[unit cutting work service]
=1.5x[unit cutting work service]
=1.5<cutting work service, time, #, #>
+3.75^{∧}<electricity, KWh, #, #>
+19.35<CO₂, Kg, #, #>
+0.3^{∧}<labor service, time, #, #>
+1.5^{∧}<cutting machine usage service, time, #, #> ... (1)
x[iron plate cutting work service: scrap]
=¼×hour of use[cutting work service]×x[unit cutting work service]
=0.5x[unit cutting work service]
=0.5<cutting work service, time, #, #>
+1.25^{∧}<electricity, KWh, #, #>
+6.45<CO₂, Kg, #, #>
+0.1^{∧}<labor service, time, #, #>
+0.5^{∧}<cutting machine usage service, time, #, #> ... (2)

Similarly, the support information generation unit 134 proportionally divides the cutting work service used in the event of production of a copper plate cut product in progress into the service for producing a copper plate cut product in progress and the service for producing the copper scrap. Hereinafter, the former will be denoted by x[copper plate cutting work service: product] and the latter will be denoted by x[copper plate cutting work service: scrap].

First, the hour of use of the cutting work service in the event of production of a copper plate cut product in progress is extracted.

Hour of use[cutting work service]
=|Pro[^{∧}<cutting work service, time, #, #>](x[production of

copper plate cut product in progress])|

=|1^{∧}<cutting work service, time, #, #>|=1
x[copper plate cutting work service: product]
=¾×hour of use[cutting work service]×x[unit cutting work service]
=0.75x[unit cutting work service]
=0.75<cutting work service, time, #, #>
+1.875^{∧}<electricity, KWh, #, #>
+9.675<CO₂, Kg, #, #>
+0.15^{∧}<labor service, time, #, #>
+0.75^{∧}<cutting machine usage service, time, #, #> ... (3)
x[copper plate cutting work service: scrap]
=¼×hour of use[cutting work service]×x[unit cutting work service]
=0.25x[unit cutting work service]
=0.25<cutting work service, time, #, #>
+0.625^{∧}<electricity, KWh, #, #>
+3.225<CO₂, Kg, #, #>
+0.05^{∧}<labor service, time, #, #>
+0.25^{∧}<cutting machine usage service, time, #, #>... (4)

The support information generation unit 134 stores the derived information of (1)˜(4) in the support information storing unit 126 as management support information. The support information provision unit 136 transmits the information of (1)˜(4) to the accounting system 106 when a predetermined condition for provision is met. The accounting system 106 runs a MFCA data process using the information of (1)˜(4).

In one variation, the support information generation unit 134 may generate, as management support information, information indicating that 0.75x[unit cutting work service] per one piece of painted product is used to produce the scrap (the iron scrap and the copper scrap in this case) based on (2) and (4). In the case of electricity, the support information generation unit 134 may generate, as management support information, information indicating that 1.875̂<electricity, KWh, #, #> is input for the production of the scrap.

Further, the support information generation unit 134 may generate, as management support information, information indicating that 2.25×[unit cutting work service] per one piece of painted product is used to produce the product (the iron plate cut product in progress and the copper plate cut product in progress in this case) based on (1) and (3). In the case of electricity, the support information generation unit 134 may generate, as management support information, information indicating that 5.625̂<electricity, KWh, #, #> is input for the production of the product. As in the case of generation of cost price information described above, the support information generation unit 134 may of course convert (1)˜(4), etc. into information on monetary valuation (in units of money) by using the price data. The support information provision unit 136 may transmit the management support information shown in the variation to the accounting system 106.

2-3. Extraction of Energy Accounting Information:

Energy is generally earmarked as indirect cost. In this embodiment, however, the price cost of energy is directly calculated by dealing with energy as an input element of the cutting work service and the press work service in the service transaction information B1˜B3.

The transaction recording unit 132 may record the following service transaction information on services like illumination and air conditioning that use electricity based on the event information, though this is not shown in the exemplary case described above.

a<illumination service,lmh,#,#>+b̂<electricity,KWh,#,#>

c<air conditioning service,KWh,#,#>+ĉ<electricity,KWh,#,#>

This serves to clarify that (1) the air conditioning service and the illumination service are generated, (2) these services are input to generation of a further service, (3) and the services are consumed. It also serves to clarify the energy usage profile.

As in the case of generation of price cost information described above, the support information generation unit 134 may use the price data to determine the price cost by referring to the transaction information on the illumination service or the air conditioning service. The support information provision unit 136 may transmit the price cost information to the accounting system 106. This can support a data process for energy accounting in the accounting system 106.

2-4. Creation of BOM

In production management, management of the BOM code system and formulation of a plan for procurement of materials according to Materials Requirements Planning (MRP) and based on BOM are important managerial items.

As already described, the transaction recording unit 132 records article transaction information that includes input elements and output elements related to the production of a finished product (referred to as “finished product transaction information” here), wherein the input elements include a product in progress. The transaction recording unit 132 also records article transaction information that includes input elements and output elements related to the production of a product in progress (referred to as “product in progress transaction information” here), wherein the input elements include a further product in progress or a source material. In this exemplary case, the transaction information (A4) on the production of a painted product corresponds to the finished product transaction information, and the transaction information (A1˜A3) on the production of a press molded product in progress, production of an iron plate cut product in progress, and production of a copper plate cut product in progress correspond to the product in progress transaction information.

The support information generation unit 134 generates BOM information as management support information by backwardly tracking the production process to extract information on a product in progress from the finished product transaction information and then to extract another product in progress from the product in progress transaction information related to the extracted product in progress, thereby extracting products in progress successively. As described later, tracking of the production process is terminated at point of time when only the source materials (the iron material, the copper material, etc.) can be retrieved from the input elements.

In this exemplary case, the support information generation unit 134 generates the following expressions based on a plurality of pieces of article transaction information stored in the transaction information storing unit 122. Information indicating whether the element is an input element or an output element and information indicating whether the element is a finished product, product in progress, source material, or byproduct may be added to the event information and the transaction information.

ProjectSet={x[production of iron plate cut product in progress],x[production of iron plate cut product in progress],x[production of press molded product in progress],x[production of painted product]}

wherein ProjectSet denotes a set of steps for producing the painted product.

Basis_for_Product&InProcess (set of output elements) ={<iron plate cut product in progress, piece, #, #>, <copper plate cut product in progress, piece, #, #<, >press molded product in progress, piece, #, #>, <painted finished product, piece, #, #>

Hat_Basis_for_Product&InProcess ={^<iron plate cut product in progress, piece #, #>, ^<copper plate cut product in progress, piece, #, #>, ^<press molded product in progress, piece, #, #>, ^<painted finished product, piece, #, #>}

Basis_for_By Product (set of byproducts) ={<iron scrap, Kg, #, #>, <copper scrap, Kg, #, #>}

HatBasis_for_ByProduct ={^<iron scrap, Kg, #, #>, ^<copper scrap, Kg, #, #>}

Basis_for_Material (set of source materials) ={<iron material, Kg, #, #>, <copper material, Kg, #, #>, <paint, Kg, #, #>}

Hat_Basis_for_Material ={^<iron material, Kg, #, #>, ^<copper material, Kg, #, #>, ^<paint, Kg, #, #>}

Basis_for_FabService (set of fabrication services) ={<cutting work service, time, #, #>, <press work service, time, #, #>, <painting service, time, #, #>}

Hat_Basis_for_FabService ={^<cutting work senice, time. #, #>, ^<press work service, time, #, #>, ^<painting service, time, #, #>}

Hat_Basis_for_Project

=Basis_for_Product & InProcess

∪Basis_for_ByProduct

∪Basis_for_Material

∪Hat_Basis_for_FabService

∪Hat_Basis_for_Product&InProcess

∪Hat_Basis_for_ByProduct

∪Hat_Basis_for_Material

∪Hat_Basis_for_FabService

The support information generation unit 134 performs the following operations to obtain the sequence (partial order) of steps. First, a projection operation is performed on the transaction information on the production of a finished product.

1) Next to production of painted product

={Pro[a](x[production of painted product])|aϵHat_Basis_forProduct&InProcess∪HatBasis_for_Material}

={1^<press molded product in progress, piece, #,#>, 2^<paint, Kg, #,#>}

This is a projection operation to extract the product in progress and the source material as input elements from the transaction information on the production of a painted product.

The support information generation unit 134 then performs a projection operation on the transaction information on the production of a press molded product in progress extracted in 1).

2) Next to production of press molded product in progress

={Pro[a](x[press molded product in progress])aϵHat_Basis_for_Product&InProcess∪Hat_Basis_for_Material}

={1^<iron plate cut product in progress, piece, #,#>, 1^<copper plate cut product in progress, piece, #,#>}

This is a projection operation to extract the product in progress and the source material as input elements from the transaction information on the production of a press molded product in progress.

The support information generation unit 134 then performs a projection operation on the transaction information on the production of an iron plate cut product in progress and the production of a copper plate cut product in progress extracted in 2).

3) Next to production of iron plate cut product in progress

={Pro[a](x[iron plate cut product in progress])|aϵHat_Basis_for_Product&InProcess∪Hat_Basis_for_Material}

={20^<iron material, Kg, #,#>}

3) Next to production of copper plate cut product in progress

={Pro[a](x[copper plate cut product in progress])|aϵHat_Basis_for_Product&InProcess∪Hat_Basis_for_Material}

={8^<copper material, Kg, #,#>}

Through the above operations, the following inputs of materials are derived.

Painted product 1 piece

Paint 2 kg
Press molded product in progress 1 piece

Iron plate cut product in progress 1 piece

Iron material 20 Kg

Copper plate cut product in progress 1 piece

Copper material 8 Kg

The support information generation unit 134 then extracts the input time of fabrication services that should be described in BOM as follows.

5) Fab_Service_of_production of painted product
={Pro[a](x[production of painted product])|a∈Hat_Basis_for_FabService}
={1^{∧}<painting service, time, #, #>}

A subsequent norm operation identifies that the input time of the painting service is 1 hour.

6) Fab_Service_of_production of press molded product in progress

={Pro[a](x[production of press molded product in progress])|aϵHat_Basis_for_FabService}

={1^<press work service, time, #,#>}

A subsequent norm operation identifies that the input time of the press work service is 1 hour.

7) Fab_Service_of_production of copper plate cut product in progress

={Pro[a](x[production of copper plate cut product in progress])|aϵHat_Basis_for_FabService}

={1^<cutting work service, time, #,#>}

A subsequent norm operation identifies that the input time of the cutting work service is 1 hour.

8) Fab_Service_of_production of iron plate cut product in progress

={Pro[a](x[production of iron plate cut product in progress])|aϵHat_Basis_for_FabService}

={2^<cutting work service, time, #,#>}

A subsequent norm operation identifies that the input time of the cutting work service is 2 hours.

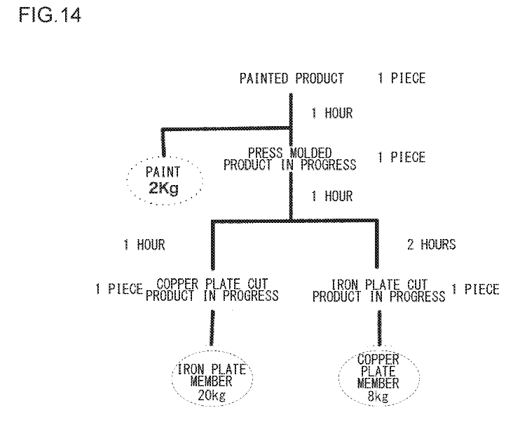

The support information generation unit 134 generates the BOM data shown in FIG. 14 by adding the information on the input time of fabrication services derived in 5)˜8) to the inputs of materials derived in 1)˜4). The support information provision unit 136 transmits the BOM data to the production management system 108 when a predetermined condition for provision is met.

2-5. Generation of Planning Support Information.

Generally, the procurement planning formulated in MRP does not allow for production scheduling and yields a plan in which unlimited production capability is assumed. With reference to FIG. 11, it will be assumed, by way of easily understood example, that 1000 pieces of painted products are delivered at a predetermined date and time. According to procurement planning based only on BOM, 1000 pieces of press molded products in progress and 2000 Kg of paint will have to be made available 1 hour before the delivery or earlier. Further, due to the time required for the press work, 1000 pieces each of iron plate cut product in progress and copper plate cut product in progress will have to be made available 1 hour before the painting. Still further, because 1 hour is consumed for the cutting work of the copper plate and 2 hours for the cutting work of the iron plate, 8000 Kg of copper material will have to be made available 1 hour before the press work, and 20000 Kg of iron material will have to be made available 2 hour before the press work.

If there is only one cutting machine available for the cutting work, however, the procurement planning should be re-examined fundamentally. This is because, even if the iron material and the copper material are made available, a total of 3 hours is required for a process associated with 1 piece of panted product. To process 1000 pieces of painted products, a total of 3000 hours will be required. If it is given that one press machine is available and that the press work is successively performed immediately when a product in progress is available for copper plate cutting or iron plate cutting, one set of cut products in progress will be completed every 3 hours. Therefore, the production of 1000 pieces of press molded products in progress will be completed after 3001 hours since the start of the initial cutting work. If it is given that one painter is available for the painting task, it will be 30002 hours since the start of the initial cutting work that all painting tasks are completed. This is because it is assumed that only one set of resources (the cutting machine, press machine, painter) are available in the fabrication services B1˜B3 provided in the respective steps.

Conversely, given a situation where all necessary work service resources are provided (e.g., a situation where 2000 cutting machines, 1000 press machines, and 1000 painters are made available), the whole work is completed in 4 hours. Under the constraint on work resources actually available, the work is scheduled on a practical basis between the upper limit and the lower limit. In MRP where unlimited resources are postulated, an excessive inventory is carried inherently. A major factor is the constraint on resources including production machines and personnel. Apart from source materials and products in progress, planning for resource allocation such as allocation of production machinery and personnel in units of time is necessary in a production process. It is difficult, merely by means of MRP-like material procurement planning based on BOM, to solve a problem associated with scheduling of allocation of resources created due to the constraint on resources for execution of work services such as processing machinery and labor resources.

In the exemplary case described above, information on scheduling is defined in the transaction information B1˜B3 on fabrication services. In order to provide 1 hour of cutting work service, 2.5 KWh of electricity, 0.2 hour of labor, and 1 hour of use of the cutting machine are necessary. Further, in order to provide 1 hour of press work service, 10 KWh of electricity, 1 hour of labor, and 1 hour of use of the press machine are necessary. Still further, in order to provide 1 hour of painting service, 1 hour of labor of the painter is necessary. The most critical bottleneck resource will be focused for the purpose of scheduling. In the three services of cutting, pressing, and painting, the cutting machine, press machine, and painter represent the bottleneck resources, respectively. The timing of supplying these resources determines the schedule of the whole process.

As in the case of generating BOM, the support information generation unit 134 identifies the sequence of a plurality of article production tasks. In this exemplary case, the support information generation unit 134 identifies the sequence of production of iron plate cut product in progress and production of copper plate cut product in progress (these are in parallel)->production of press molded product in progress->production of painted product. The support information generation unit 134 identifies a service used in each article production task and performs a projection operation to extract a bottle neck resource and the hour of use thereof in the transaction information on the identified service. In the event information and the transaction information, a flag indicating that an input element is a bottleneck resource may be added to the input element if that is the case. Alternatively, a predetermined, specific input element (resource) may be defined as a bottleneck resource and information indicating the definition may be stored in the transaction information storing unit 122.

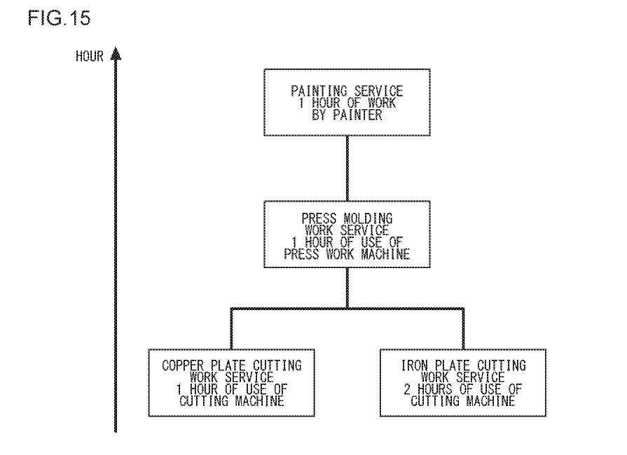

The support information generation unit 134 arranges the services used in a plurality of article production tasks in the order of execution of the tasks to generate service flow information that describes the bottleneck element in each service and the hour of use thereof. FIG. 15 shows an example of service flow information generated in this exemplary case. The figure can be said to be a service deployment sheet. The support information generation unit 134 stores the service flow information and the resource constraint information (FIG. 1) related to predefined workers and machines in the support information storing unit 126, mapping the service flow information to the resource constraint information. The support information provision unit 136 transmits the service flow information and the resource constraint information to the production management system 108 as management support information.

Various schemes for production planning have been proposed in the form ERP packages, etc. However, the related-art schemes have required complicated management such as separately building a database related to resource constraint. According to the embodiment, the resource necessary for the execution of a task and the time occupied by the resource are extracted from a description of the task (transaction information) described in exchange algebra and the extracted information is provided to the production management system 108. The production management system 108 can easily calculate a dynamic plan for resource allocation and information such as a Gantt Chart, using the information provided by the management support device 102 and a known algorithm (e.g., the algorithm for a dynamic resource placement problem in a parallel project proposed by the inventor of this disclosure in JP Application 2011-104944).

In the embodiment described above, we propose describing the POE data for corporate article production tasks and service tasks in the form of transaction information in the double-entry bookkeeping format using real object accounts and service accounts. This enables integrated design, implementation, and management of information for supporting corporate management of various corporate activities comprised of article production tasks and service tasks, through financial accounting, price cost calculation, MRP, production planning, and environment accounting, etc. In implementing the method proposed in this embodiment in the form of information processing, there is no need to build a top-down system based on a database.

In the related-art methods, the financial accounting data, price cost calculation data, component procurement data, production planning data, environment management data, etc. are managed by separated databases. This has required extremely complicated management such as coordination between the data, and alignment between data systems built on the foundations of different codes, etc. According to the method proposed in the embodiment, on the other hand, the data are managed in a unified manner (managed by the name) according to a code system based on items of goods and service accounts used in describing a transaction in a task. Various information necessary for corporate management is automatically obtained by an algebraic operation by using AMBS data (transaction information) as a unified, common source and referring to a parameter such as resource constraint information as appropriate. The codes for components, products in progress, and finished products shared by information necessary for corporate management can also be dealt with in an integrated manner by using the bases of AMBS.

It should also be noted that manufacturing, at the designing stage and subsequently, requires various plans directed toward production such as material procurement plans and price cost calculation. These plans should also incorporate consideration for a series of processes from the source material (component), product in progress to the finished product, for price cost management, and for production scheduling. In the AMBS-based production management approach according to the embodiment, unified information management based on AMBS can be realized through the three phases including 1) design phase, 2) process planning phase, and 3) process execution management phase.

In the design phase of 1), organizing of source materials and products in progress, component procurement planning, and production cost calculation are called for at the stage of designing a process from the source material (component), product in progress to the finished product by using CAD, etc. We have already shown that the management support device 102 easily calculates the price cost of the production service, product in progress, and finished product by referring to a description of a task (transaction information) in the multi-dimensional bookkeeping format and by using the price information. This means, at the same time, that risk management information of the price cost can be obtained by defining, as a scenario, variation in various factors such as material and energy cost, labor expense, capital cost for equipment and devices (usage service fee for devices, etc.), processing cost for bads, etc.

In the process planning phase of 2), MRP-like inventory management or order management can be practiced based on the BOM information and service flow information provided by the management support device 102. In the process execution management phase of 3), various task management in the actual operation can be practiced based on various management support information provided by the management support device 102. An actual production process may often divert from the plan, but the management support device 102 according to the embodiment generates and timely provides management support information that reflects the latest event information and parameters throughout the phases 1)˜3) above. This allows the accounting system 106 and the production management system 108 to perform accounting processes and production management processes adapted to the latest situation.

In the embodiment, management of an “article” manufacturing process has been described by way of example. However, description of manufacturing tasks as transactions in the multi-dimensional bookkeeping format using real object accounts and the resultant framework of information system design for integrated design, implementation, and management of a manufacturing project can also be applied to a project other than manufacturing that is comprised of service tasks. Examples will be given in the following.

(1) Service Project of Interior Finish Work:

In the case of interior finish work for a condominium, etc., a package of work for one room can be described in the form of a project in which tasks including flooring, electrical work, piping work, etc. are linked in a partial order relation. While some materials are put into the project, the main concern is scheduling of human resources such as electricians who provide the service. However, material planning is also necessary at the same time. In this sense, material planning and scheduling in a construction project such as interior finish work can both be dealt with in an integrated manner by using the approach of the embodiment.

(2) Clinical Path in Medicine

A medical care process in medicine is described as a series of medical tasks such as diagnosis, examination, etc. and a project comprised of a chain of the tasks. Input of materials in individual tasks and scheduling of resources for execution of tasks such as doctors, nurses, examination devices, etc. are challenges that should be addressed in this case as well. The framework of this embodiment can be easily applied to these cases.

(3) Various Service Flows:

Not only those services in manufacturing, interior finish work, and medical clinical path described above but also those including even the support service at disaster evacuation centers and the service for tourists and aged persons can be represented in the form of individual tasks of the service and a project that links the tasks in a partial order relation. In this approach, it is required to integrally define an individual task, lay out a plan to input materials to execute the individual task, and draft scheduling related to resources to execute the service. The method proposed in the embodiment of breaking down an individual task into a material input portion and a service input portion and formulating the task in the AMBS style of description is capable of integrally supporting, in a highly generalized manner, a variety of management operations including cost calculation, material planning, scheduling, etc. of a project comprised of a plurality of tasks.

In the related-art management of article and service production projects, information is entered discretely, and building of a complicated database and time-consuming maintenance have been required. By way of contrast, the management support device 102 according to the embodiment records transaction information for every event in a task (e.g., a task of producing a product in progress and a task of producing a finished product) constituting the critical path of a project. According to the embodiment, an integrated management system related to service and production can be built based on a consistent principle and in a manner easy to manage, solely upon the foundation of a description in the transaction format in units of real objects.

Building of a system based on a description of a transaction related to task execution does not require a large-scale database or management thereof. It is also possible to modify the corporate system 100 hosting such a system in a robust manner in response to post facto improvements and modifications to the production or the service. For example, recombination of schedules in the middle of production can be addressed flexibly by using data described in the AMBS style and applying a publicly known dynamic scheduling algorithm.

Further, apart from the issue of planning, a variety of form of performance-based management of the execution of an actual process is also possible by linking Point of Production (POP) event data in a production system to an AMBS description related to processing of a task or a service. In the age of IoT and IoE, real-time transaction processes are easy by linking various POE events with the data generated concurrently. It is far more flexible to design such a system as an autonomous, distributed, and cooperative system as in the embodiment, instead of as a gigantic system like that of a cloud.

The architecture proposed in the embodiment is founded upon representation of production information using exchange algebra and record type parameter data (data algebra) and performs calculations as a data flow by transferring or converting the representation in a variety of manner. Such a system accommodates constant post facto improvements and additions. Also, introduction of the system can start with a necessary portion. Further, the task data is formed at a small capital cost and is built on a concept easy to be understood by the personnel on the field.

In the related-art database solution that starts with an E-R diagram and leads to generation of a database, on the other hand, a large number of data tables are built as databases to comply with a concept different from the management concept on the field. The business logic is built on a top-down basis. It is extremely difficult to build a process in which feedback for possible improvements from the field is incorporated. The process is defined as something that should be implemented in the field.

The architecture according to the embodiment enables a person just having an understanding on double-entry multi-dimensional description and algebraic representation thereof to formulate tasks according to a concept familiar in the field and to derive various data necessary for production management from the chain of the tasks. This is true not only of manufacturing but also of various forms of service production. The system can be designed from bottom up and introduced, as one that is tolerant to constant improvements, in a production project or a service project not only in a single corporation but also in numerous organizations connected together to support price cost management etc. and, ultimately, production management of articles and services.

As discussed above, the management support method proposed in the embodiment and related to article and service production postulates a plurality of scenarios of price, technology (investment in facilities, etc.), environment constraint, etc. based on event information (input parameters) like (1) the amount of input of source material, labor, energy, device, (2) the amount of main product, byproduct, and service produced each measured in units of real objects, and evaluates the technology (investment in facilities, etc.) and plans for production from various perspectives defined by price unit, material unit, evaluation of waste, etc. The management support method is applicable to management of a plurality of processes including (1) basic design of a manufacturing process, (2) introduction of a production system in a factory including the facilities, (3) production process adapted to orders received, etc. Stated otherwise, the method can support managerial operations of the respective processes.

Described above is an explanation based on an exemplary embodiment. The embodiment is intended to be illustrative only and it will be understood by those skilled in the art that various modifications to constituting elements and processes could be developed and that such modifications are also within the scope of the present invention.

Any combination of the embodiment and a variation will also be useful as an embodiment of the present invention. A new embodiment created by a combination will provide the combined advantages of the embodiment and the variation as combined. It will be understood to a skilled person that the functions achieved by the constituting elements recited in the claims are implemented either alone or in combination by the constituting elements shown in the embodiment and the variation.

### EXPLANATION OF REFERENCE NUMERALS

100 corporate system, 102 management support device, 120 basis information storing unit, 122 transaction information storing unit, 124 parameter storing unit, 126 support information storing unit, 130 event acknowledgment unit, 132 transaction recording unit, 134 support information generation unit, 136 support information provision unit

### INDUSTRIAL APPLICABILITY

The present invention is applicable to an information processing device.

1. A management support device comprising;
an event acknowledgment unit that acknowledges event information including a numerical quantity of an input element constituting an event generated in a predetermined organization and a numerical quantity of an output element constituting the event;
a transaction recording unit that records transaction information described in a double-entry bookkeeping style, the transaction information being an exchange algebraic representation of the event information acknowledged by the event acknowledgment unit, the transaction information indicating the input element as a credit side item and quantifying the input element in units of quantity for the input element, and the transaction information indicating the output element as a debit side item and quantifying the output element in units of quantity for the output element; and
an information generation unit that generates a plurality of types of support information for supporting management of the organization according to a plurality of schemes, in accordance with the transaction information recorded by the transaction recording unit.

2. The management support device according to claim 1, wherein
the transaction recording unit records article transaction information that includes an input element and an output element related to production of an article, and service transaction information that includes an input element and an output element related to production of a service input to the production of the article, and
the information generation unit generates the plurality of types of support information in accordance with the article transaction information and the service transaction information.

3. The management support device according to claim 1, wherein
the information generation unit generates, as one of the plurality of types of support information, information indicating a price cost of the output element in the transaction information by converting the numerical quantity of the input element indicated in the transaction information in units of quantity for the input element into a representation in units of money, according to price information on the input element.

4. The management support device according to claim 2, wherein
the output element in the article transaction information includes the article and a byproduct generated in association with the production of the article, and
the information generation unit generates information, as one of the plurality of types of support information, information indicating a numerical quantity of the input element used in producing the byproduct by proportionally dividing the numerical quantity of the input element indicated by the service transaction information according to a proportion of the article produced relative to that of the byproduct indicated by the article transaction information.

5. The management support device according to claim 1, wherein
the transaction recording unit records finished product transaction information that includes an input element and an output element related to production of a finished product, wherein the input element includes a product in progress, and the transaction recording unit also records product in progress transaction information that includes an input element and an output element related to production of the product in progress, wherein the input element includes a further product in progress, and
the information generation unit generates, as one of the plurality of types of support information, information on a component parts sheet, by tracking a production process to extract information on a product in progress from the finished product transaction information and then to extract a further product in progress from the product in progress transaction information related to the extracted product in progress, thereby extracting products in progress successively.

6. A management support method comprising:
acknowledging, using a computer, event information including a numerical quantity of an input element constituting an event generated in a predetermined organization and a numerical quantity of an output element constituting the event;
recording, using a computer, transaction information described in a double-entry bookkeeping style, the transaction information being an exchange algebraic representation of the event information acknowledged, the transaction information indicating the input element as a credit side item and quantifying the input element in units of quantity for the input element, and the transaction information indicating the output element as a debit side item and quantifying the output element in units of quantity for the output element; and
generating, using a computer, a plurality of types of support information for supporting management of the organization according to a plurality of schemes, in accordance with the transaction information recorded.

7. A management support method for postulating a plurality of scenarios of price, technology (investment in facilities, etc.), environment constraint, etc. based on event information indicating (1) an amount of input of source material, labor, energy, device, (2) an amount of main product, byproduct, and service produced, and for evaluating a technology (investment in facilities, etc.) and a plan for production from various perspectives defined by price unit, material unit, evaluation of waste, etc.

8. A computer program comprising computer-implemented modules including:
an acknowledgment module that acknowledges event information including a numerical quantity of an input element constituting an event generated in a predetermined organization and a numerical quantity of an output element constituting the event;
a recording module that records transaction information described in a double-entry bookkeeping style, the transaction information being an exchange algebraic representation of the event information acknowledged by the acknowledgment module, the transaction information indicating the input element as a credit side item and quantifying the input element in units of quantity for the input element, and the transaction information indicating the output element as a debit side item and quantifying the output element in units of quantity for the output element; and
a generation module that generates a plurality of types of support information for supporting management of the organization according to a plurality of schemes, in accordance with the transaction information recorded by the acknowledgment module.
